(19) United States
(12) Patent Application Publication
(10) Pub. No.: US 2017/0235600 A1
(43) Pub. Date: Aug. 17, 2017

(54) SYSTEM AND METHOD FOR RUNNING APPLICATION PROCESSES

(71) Applicant: TSX INC., Toronto (CA)

(72) Inventors: Tudor MOROSAN, Toronto (CA); Gregory A. ALLEN, Oakville (CA)

(21) Appl. No.: 15/308,683

(22) PCT Filed: May 8, 2014
(86) PCT No.: PCT/CA2014/000406

§ 371 Date: Mar. 15, 2017

(51) Int. Cl. G06F 9/48; G06F 9/54; G06F 9/50

(52) U.S. Cl. CPC G06F 9/4881; G06F 9/5016; G06F 9/5027; G06F 9/545; G06F 9/546

(57) ABSTRACT

A server and method for processing data records are provided. The server includes an operating system running on a dedicated processor core, a memory storage facility, a first application process thread running on a first dedicated core and a second application process thread running on a second dedicated core. The dedicated cores are in communication with the memory storage facility and configured to run threads autonomously. The method involves scheduling non-deterministic threads, initiating an application process, storing data, and running process threads autonomously from the operating system.

### FIELD

The present invention relates to computer and network architecture and more particularly relates to a system and method for running application processes.

### BACKGROUND

Society is increasingly relying on computers and networks to interact and conduct business. To achieve a high level of availability demanded in critical systems, unplanned downtime caused by software and hardware defects should be minimized.

The financial services industry is but one example of an industry that demands both high performance processing and highly available systems. Indeed, a large number of data processing activities in today's financial industry are supported by computer systems. Particularly interesting are the so-called “real-time” and “near real-time” On-Line Transaction Processing (OLTP) applications, which typically process large numbers of business transactions over a prolonged period, with high speed and low latency. These applications generally exhibit the following characteristics: (1) complex and high speed, low latency data processing, (2) reliable, recoverable data storage, and (3) high level of availability, i.e. the ability to support the services on a substantially uninterrupted basis. When implemented, existing applications tend to tradeoff between these performance requirements due to their contradictory effects on the system behavior and no designs can completely satisfy all of the three characteristics simultaneously, as outlined in greater detail below.

First, complex high speed, low latency data processing refers to the ability to perform, in a timely fashion, a large number of computations, database retrievals/updates, etc., and the ability to reliably produce the results in as short a time interval as possible. This can be implemented through parallel processing, where multiple units of work are executed simultaneously on the same physical machine or on a distributed network. In some systems, the outcome of each transaction depends on the outcomes of previously completed transactions. The parallel aspects of such systems are, inherently, non-deterministic: due to race conditions, operating system scheduling tasks, or variable network delays, the sequence of message and thread execution cannot be predicted, nor can replicas of such systems be processed in parallel to achieve high availability simply by passing copies of input messages to the duplicate system. Duplicate non-deterministic systems have non-identical output. Additionally, operating system scheduling of tasks and variable network delays can result in highly variable processing time latency. Therefore, high performance, non-deterministic systems present severe challenges to running two processes in parallel on two different computing machines with the intention of having one substitute for the other in case of failure. If a system implements parallel processing on a distributed network of computers to achieve high speed processing, the additional cost and complexity of providing duplicate systems and the networking to link them all together can become highly problematic.

Second, reliable recoverable data storage refers to the ability to store the processed data persistently, even if a number of the system's software or hardware components experience unexpected failure. This can usually be implemented by using Atomic, Consistent, Isolated, and Durable (“ACID”) transactions when accessing or modifying the shared data. ACID transactions can ensure the data integrity and persistence as soon as a unit of work is completed. Every committed ACID transaction is synchronously written into the non-volatile computer memory (hard-disk), which helps ensure the data durability, but it is very costly in terms of performance and typically slows down the system.

Third, highly available systems attempt to ensure that the percentage availability of a given computer system is as close as possible to 100%. Such availability can be implemented through redundant software and/or hardware, which takes over the functionality in the event a component failure is detected. In order to succeed, the failover replicates not only the data, but also the process state. As will be appreciated by those of skill in the art, state replication can be particularly challenging in non-deterministic systems (i.e. systems where computational processing of the same set of events can have more than one result depending on the order in which those events are processed). Achieving this in a high-performance system from which consistently low processing latency is demanded is even more difficult.

Highly available software applications are usually deployed on redundant environments to reduce and/or eliminate the single point of failure that is commonly associated with the underlying hardware. Two common approaches generally considered to be a form of high availability are known as hot failover and warm failover. Hot failover refers to simultaneously processing the same input in multiple systems, essentially providing complete redundancy in the event of a failure in one of those systems. Warm failover refers to replicating the state of the application (i.e. the application data in memory) in backup systems having applications capable of processing transactions and receiving updates of state changes from the primary system in the event of failure of the primary system. Cold failover, which is not considered by many to be a form of high availability, is another type of failover method and refers to simply powering-up a backup system in the event of a failure of the primary system, and preparing that backup system to assume processing responsibilities from the primary system.

In hot failover configurations, two instances of the application are simultaneously running on two different hardware facilities, processing copies of the same input. If one of the facilities experiences a critical failure, a supplemental synchronization system can ensure that the other one will continue to support the workload. Hot failover configurations only work for deterministic systems, where processing duplicate input is guaranteed to produce identical output. Non-deterministic systems can only work with warm failover configurations. In the warm failover configurations, one of the systems, designated primary, is running the application and processing input; in case of failure, the second system, designated backup, which being updated with application state changes from the primary system, will take over, and resume processing of input.

Prior art warm failover approaches for non-deterministic systems have at least two disadvantages. First, supplemental software has to run in order to keep the two systems synchronized. In the case of real-time or near real-time systems, this synchronization effort can lead to an unacceptable (or otherwise undesirable) decrease in performance and increased complexity where the order of processing of input must be guaranteed to be identical. Also, prior art parallel-processing systems used in such high performance applications typically allow multiple threads to execute simultaneously, so they are inherently non-deterministic due to the unpredictability of operating system task scheduling. Also non-deterministic are the systems with servers and geographically distributed clients, where the variable network delay delivers the messages originating from diverse clients to the server in an unpredictable sequence.

Cold failover can be used to overcome certain problems associated with warm failover. Cold failover can be another way to implement failover of non-deterministic systems by replicating the system data to a redundant backup system's disk storage and then starting up the application on the secondary system. This approach has its drawbacks in the time required to recover the data to a consistent state, then to bring the application up to a functional state, and lastly, to return the application to the latest point in processing or which data was saved. This process normally takes hours, requires manual intervention, and cannot generally recover in-flight transactions, or even transactions that were processed after the last time that data was replicated to the backup system's disk storage, but before the primary system failed.

A number of patents attempt to address at least some of the foregoing problems. U.S. Pat. No. 5,305,200 proposes a non-repudiation mechanism for communications in a negotiated trading scenario between a buyer/seller and a dealer (market maker). Redundancy is provided to ensure the non-repudiation mechanism works in the event of a failure. It does not address the failover of an on-line transactional application in a non-deterministic environment. In simple terms, U.S. Pat. No. 5,305,200 is directed to providing an unequivocal answer to the question: “Was the order sent, or not?” after experiencing a network failure.

U.S. Pat. No. 5,381,545 proposes a technique for backing up stored data (in a database) while updates are still being made to the data. U.S. Pat. No. 5,987,432 addresses a fault-tolerant market data ticker plant system for assembling world-wide financial market data for regional distribution. This is a deterministic environment, and the solution focuses on providing an uninterrupted one-way flow of data to the consumers. U.S. Pat. No. 6,154,847 provides an improved method for rolling back transactions by combining a transaction log on traditional non-volatile storage with a transaction list in volatile storage. U.S. Pat. No. 6,199,055 proposes a method for conducting distributed transactions between a system and a portable processor across an unsecured communications link. U.S. Pat. No. 6,199,055 deals with authentication, ensuring complete transactions with remote devices, and with resetting the remote devices in the event of a failure. In general, the foregoing does not address the failover of an on-line transactional application in a non-deterministic environment.

U.S. Pat. No. 6,202,149 proposes a method and apparatus for automatically redistributing tasks to reduce the effect of a computer outage. The apparatus includes at least one redundancy group comprised of one or more computing systems, which in turn are themselves comprised of one or more computing partitions. The partition includes copies of a database schema that are replicated at each computing system partition. The redundancy group monitors the status of the computing systems and the computing system partitions, and assigns a task to the computing systems based on the monitored status of the computing systems. One problem with U.S. Pat. No. 6,202,149 is that it does not teach how to recover workflow when a backup system assumes responsibility for processing transactions, but instead directs itself to the replication of an entire database which can be inefficient and/or slow. Further, such replication can cause important transactional information to be lost in flight, particularly during a failure of the primary system or the network interconnecting the primary and backup system, thereby leading to an inconsistent state between the primary and backup. In general, U.S. Pat. No. 6,202,149 lacks certain features that are desired in the processing of on-line transactions and the like, and in particular lacks features needed to failover non-deterministic systems.

U.S. Pat. No. 6,308,287 proposes a method for detecting a failure of a component transaction, backing it out, storing a failure indicator reliably so that it is recoverable after a system failure, and then making this failure indicator available to a further transaction. It does not address the failover of a transactional application in a non-deterministic environment.

U.S. Pat. No. 6,574,750 proposes a system of distributed, replicated objects, where the objects are non-deterministic. It proposes a method for guaranteeing consistency and limiting roll-back in the event of the failure of a replicated object. A method is described where an object receives an incoming client request and compares the request ID to a log of all requests previously processed by replicas of the object. If a match is found, then the associated response is returned to the client. However, this method in isolation is not sufficient to solve the various problems in the prior art. Another problem is that the method for U .S. Pat. No. 6,575,750 assumes a synchronous invocation chain, which is inappropriate for high-performance On-Line Transaction Processing (“OLTP”) applications. With a synchronous invocation the client waits for either a reply or a time-out before continuing. The invoked object in turn can become a client of another object, propagating the synchronous call chain. The result can be an extensive synchronous operation, blocking the client processing and requiring long time-outs to be configured in the originating client.

### SUMMARY

In accordance with an aspect of the specification, there is a server for running an application process having a first process thread and a second process thread. The server includes at least one non-dedicated processor core configured to run an operating system. The at least one non-dedicated processor core configured to schedule non-deterministic threads and to initiate the application process. The server also includes a memory storage facility for storing data during execution of the application process. In addition, the server includes a first dedicated core in communication with the memory storage facility. The first dedicated core is configured to run the first process thread in isolation from the operating system. The first process thread is configured to exclude making calls using the operating system. Furthermore, the server includes a second dedicated core in communication with the memory storage facility. The second dedicated core is configured to run the second process thread in isolation from the operating system. The second process thread is configured to exclude making calls using the operating system.

The first dedicated core and the second dedicated core may be configured to share data via the memory storage facility using a pointer variable maintained within the application process.

The first process thread and the second process thread may be configured to share data by storing the pointer variable in a cache memory unit.

The first dedicated core may be configured to run the first process thread in a loop continuously.

The second dedicated core may be configured to run the second process thread in a loop continuously.

The first process thread and the second process thread may be configured to generate deterministic results.

The first dedicated core and the second dedicated core may be pre-selected to optimize use of the memory storage facility.

The first process thread running on the first dedicated core may be configured to access a first queue. The first queue may be for storing a first pointer to the data to be processed by the first dedicated core.

The first process thread running on the first dedicated core may be further configured to continuously poll the first queue for additional data to be processed.

The second process thread running on the second dedicated core may be configured to access a second queue. The second queue may be for storing a second pointer to the data to be processed by the second dedicated core.

The second process thread running on the second dedicated core may be further configured to continuously poll the second queue for additional data to be processed.

The memory storage facility may include a portion dedicated to the application process.

The first dedicated core may operate within a first processor and the second dedicated core may operate within a second processor. The first processor and the second processor may be connected by an inter-processor bus.

In accordance with an aspect of the specification, there is provided a method for processing transactions. The method involves scheduling non-deterministic threads using an operating system running on at least one non-dedicated processor core. In addition, the method involves initiating, via the operating system, an application process having a first process thread and a second process thread. Furthermore, the method involves storing data in a memory storage facility during execution of the application process. Also, the method involves running a first process thread in isolation from the operating system on a first dedicated core in communication with the memory storage facility by excluding making calls using the operating system. The method further involves running a second process thread in isolation from the operating system on a second dedicated core in communication with the memory storage facility by excluding making calls using the operating system.

The method may further involve sharing data between the first process thread and the second process thread via the memory storage facility using a pointer variable.

Sharing may involve storing the pointer variable in a cache memory unit.

Running the first process thread may involve running the first process thread continuously in a loop.

Running the second process thread may involve running the second process thread continuously in a loop.

The method may further involve generating deterministic results using the first process thread and the second process thread.

The method may further involve pre-selecting the first dedicated core and the dedicated core to optimize use of the memory storage facility.

The method may further involve storing a first pointer in a first queue accessible by the first process thread running on the first dedicated core. The first pointer may be associated with data to be processed by the first process thread running on the first dedicated core.

The method may further involve continuously polling the first queue for additional data to be processed by the first process thread running on the first dedicated core.

The method may further involve storing a second pointer in a second queue accessible by the second process thread running on the second dedicated core. The second pointer may be associated with data to be processed by the second process thread running on the second dedicated core.

The method may further involve continuously polling the second queue for additional data to be processed by the second process thread running on the second dedicated core.

The memory storage facility may a portion dedicated to the application process.

The first dedicated core may operate within a first processor and the second dedicated core operates within a second processor. The first processor and the second processor may be connected by an inter-processor bus.

In accordance with an aspect of the specification, there is provided a non-transitory computer readable medium encoded with codes. The codes are for directing a processor to schedule non-deterministic threads using an operating system running on at least one non-dedicated processor core. The codes are also for directing the processor to initiate, via the operating system, an application process having a first process thread and a second process thread. In addition, the codes are for directing the processor to store data in a memory storage facility during execution of the application process. Furthermore the codes are for directing the processor to run a first process thread in isolation from the operating system on a first dedicated core in communication with the memory storage facility by excluding making calls using the operating system. Also, the codes are for directing the processor to run a second process thread in isolation from the operating system on a second dedicated core in communication with the memory storage facility by excluding making calls using the operating system.

In accordance with another aspect of the specification, there is provided a non-transitory computer readable medium encoded with codes for directing a first processor and a second processor. The first processor and the second processor connected by an inter-processor bus. The codes are for directing the first processor and/or the second processor to schedule non-deterministic threads using an operating system running on at least one non-dedicated processor core. In addition, the codes are for directing the first processor and/or the second processor to initiate, via the operating system, an application process having a first process thread and a second process thread. Also, the codes are for directing the first processor and/or the second processor to store data in a memory storage facility during execution of the application process. Furthermore, the codes are for directing the first processor to run a first process thread in isolation from the operating system on a first dedicated core in communication with the memory storage facility by excluding making calls using the operating system, the first dedicated core operating within the first processor. In addition, the codes are for directing the second processor to run a second process thread in isolation from the operating system on a second dedicated core in communication with the memory storage facility by excluding making calls using the operating system, the second dedicated core operating within the second processor.

### BRIEF DESCRIPTION OF THE DRAWINGS

Reference will now be made, by way of example only, to the accompanying drawings in which:

FIG. 1 is a schematic representation of a failover system in accordance with an embodiment;

FIG. 2 is a schematic representation of a first and second server in accordance with the embodiment shown in FIG. 1;

FIG. 3 is a flow chart of a method for failover in accordance with an embodiment;

FIG. 4 is a schematic representation sending a message from a client machine to a primary server in a system in accordance with the embodiment shown in FIG. 1;

FIG. 5 is a schematic representation sending a message from a primary server to a backup server in a system in accordance with the embodiment shown in FIG. 1;

FIG. 6 is a schematic representation sending a confirmation from a backup server to a primary server in a system in accordance with the embodiment shown in FIG. 1;

FIG. 7 is a schematic representation sending a verification message from a primary server to a backup server in a system in accordance with the embodiment shown in FIG. 1;

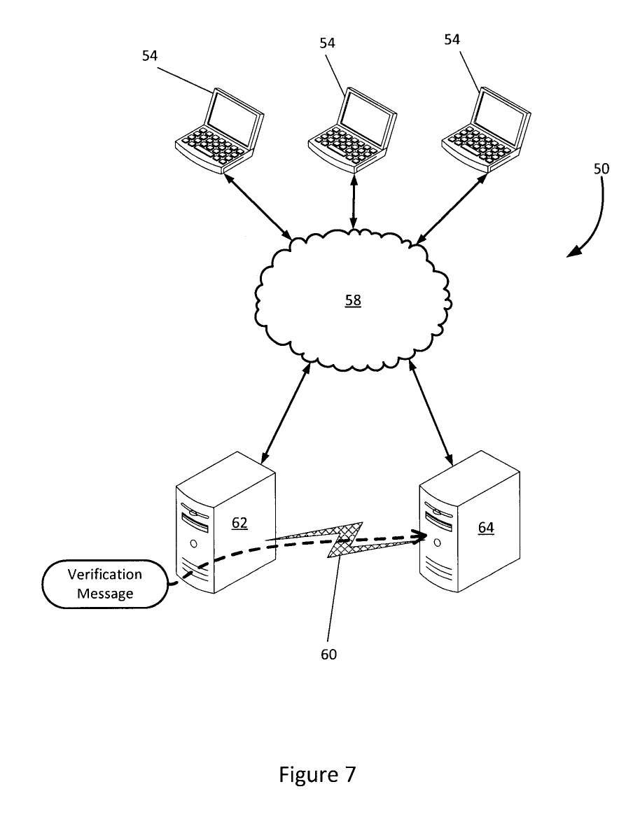

FIG. 8 is a flow chart of a method for failover in accordance with an embodiment in accordance with the embodiment of FIG. 3 during a failure;

FIG. 9 is a flow chart of a method for failover in accordance with an embodiment in accordance with the embodiment of FIG. 3 after a failure;

FIG. 10 is a schematic representation of a failover system in accordance with another embodiment;

FIG. 11 is a schematic representation of a failover system in accordance with another embodiment;

FIG. 12 is a schematic representation of a first and second server in accordance with another embodiment;

FIG. 13 is a flow chart of a method for failover in accordance with another embodiment;

FIG. 14 is a schematic representation of a first and second server in accordance with another embodiment;

FIG. 15 is a flow chart of a method for failover in accordance with another embodiment;

FIG. 16 is a schematic representation of a server in accordance with another embodiment;

FIG. 17 is another schematic representation of a server in accordance with the embodiment of FIG. 16;

FIG. 18 is a flow chart of a method for processing orders at a server in accordance with another embodiment;

FIG. 19 is a schematic representation of a server in accordance with another embodiment; and

FIG. 20 is another schematic representation of a server in accordance with the embodiment of FIG. 19.

### DETAILED DESCRIPTION OF THE EMBODIMENTS

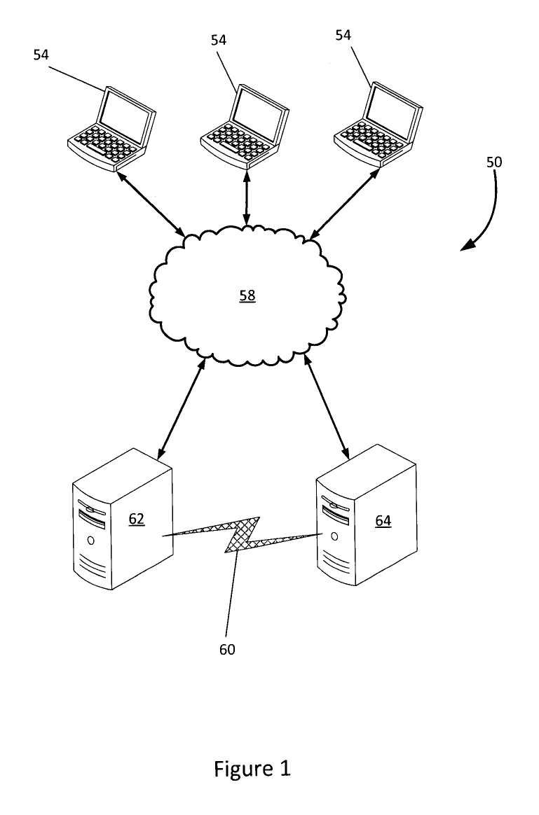

Referring now to FIG. 1, a schematic block diagram of a system for failover is indicated generally at 50. It is to be understood that the system 50 is purely exemplary and it will be apparent to those skilled in the art that a variety of systems for failover are contemplated. The system 50 includes a plurality of client machines 54 connected to a network 58. The network 58 can be any type of computing network, such as the Internet, a local area network, a wide area network or combinations thereof. In turn, the network 58 is connected to a primary server 62 and a backup server 64. In the present embodiment, the primary server 62 and the backup server 64 are connected via a direct connection 60. Accordingly, each client machine 54 can communicate with the primary server 62 and/or the backup server 64 via the network 58, and the primary server 62 and the backup server 64 can communicate with each other using the direct connection 60 as will be discussed in greater detail below. In this description, one client machine 54 is discussed. However, it should be understood that more than one client machine 54 is contemplated.

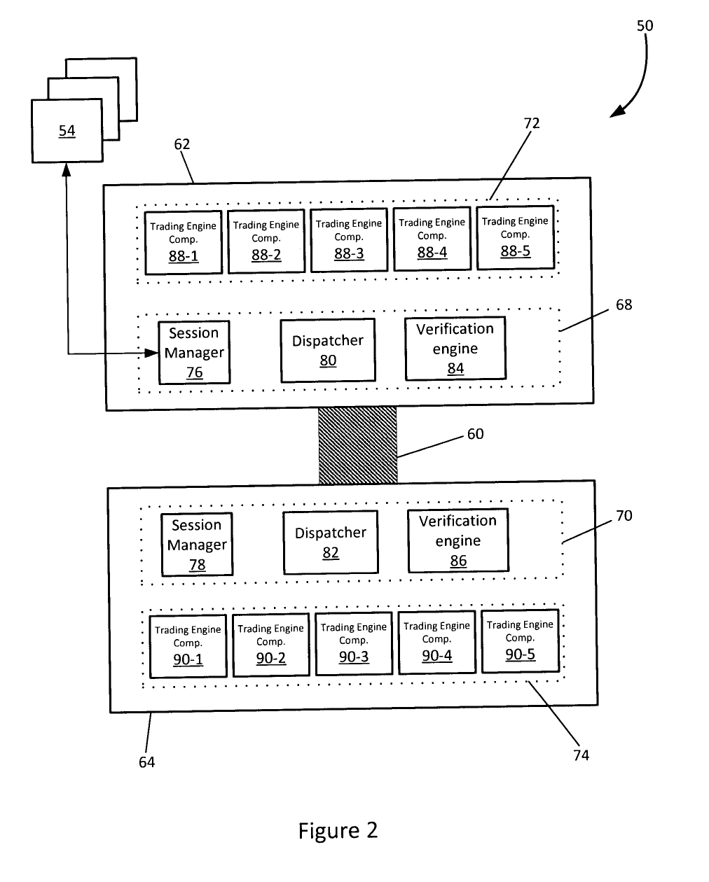

Referring to FIG. 2, a schematic block diagram of showing various components of the primary server 62 and the backup server 64 is illustrated. In the present embodiment, the direct connection 60 is a low latency link capable of transmitting and receiving messages between the primary server 62 and the backup server 64 at high a speed with accuracy. For example, the direct connection 60 can include a peripheral component interconnect express (PCIe) link such that the primary server 62 can write data directly to a memory of the backup server 64 and vice versa. It should be emphasized that the structure in FIG. 2 is purely exemplary and that variations are contemplated. For example, it is to be appreciated, with the benefit of this description, that the direct connection 60 need not be a low latency link and can be omitted altogether. If the direct connection 60 is omitted, the primary server 62 and the backup server 64 can be connected using the network 58. As another example of a variation, the direct connection 60 can be modified such that the primary server 62 and the backup server 64 are not directly connected, but instead connect via a relay device or hub.

The client machine 54 is not particularly limited and can be generally configured to be associated with an account. For example, in the present embodiment, the client machine 54 is associated with an account for electronic trading. In particular, the client machine 54 is configured to communicate with the primary server 62 and the backup server 64 for sending input messages to one or both of the primary server 62 and the backup server 64 as will be discussed in greater detail below. The client machine 54 is typically a computing device such as a personal computer having a keyboard and mouse (or other input devices), a monitor (or other output device) and a desktop-module connecting the keyboard, mouse and monitor and housing to one or more central processing units (CPU's), volatile memory (i.e. random access memory), non-volatile memory (i.e. hard disk devices) and network interfaces to allow the client machine 54 to communicate over the network 58. However, it is to be understood that client machine 54 can be any type of computing device capable of sending input messages over the network 58 to one or both of the primary server 62 and the backup server 64, such as a personal digital assistant, tablet computing device, cellular phone, laptop computer, etc.

In the present embodiment, the primary server 62 can be any type of computing device operable to receive and process input messages from the client machine 54, such as a HP ProLiant BL25p server from Hewlett-Packard Company, 800 South Taft, Loveland, Colo. 80537. Another type of computing device suitable for the primary server 62 is a HP DL380 G7 Server or a HP ProLiant DL560 Server also from Hewlett-Packard Company. Another type of computing device suitable for the primary server 62 is an IBM System x3650 M4. However, it is to be emphasized that these particular servers are merely examples, a vast array of other types of computing devices and environments for the primary server 62 and the backup server 64 are within the scope of the invention. The type of input message being received and processed by the primary server 62 is not particularly limited, but in a present embodiment, the primary server 62 operates as an on-line trading system, and is thus able to process input messages that include orders related to securities that can be traded on-line. For example, the orders can include an order to purchase or sell a security, such as a stock, or to cancel a previously placed order. More particularly in the present embodiment, the primary server 62 is configured to execute orders received from the client machine 54. The primary server 62 includes a gateway 68 and a trading engine 72 (also referred to as an order processing engine).

The gateway 68 is generally configured to receive and to handle messages received from other devices, such as the client machine 54 and the backup server 64 as well as process and send messages to other devices such as the client machine 54 and the backup server 64 in communication with the primary server 62. In the present embodiment, the gateway 68 includes a session manager 76, a dispatcher 80 and a verification engine 84.

The session manager 76 is generally configured to receive an input message from the client machine 54 via the network 58 and to send an output message to the client machine 54 via the network 58. It is to be understood that the manner by which the session manager 76 receives input messages is not particularly limited and a wide variety of different applications directed to on-line trading systems can be used.

The dispatcher 80 is generally configured to communicate with various resources (not shown) to obtain deterministic information and to assign a sequence number associated with the input message. It is to be appreciated with the benefit of this description that deterministic information can include any type of information used to maintain determinism and can include the sequence number associated with the input message. Furthermore, the dispatcher 80 is configured to dispatch the input message, the deterministic information, and the sequence number to the trading engine 72. The dispatcher 80 is further configured to dispatch or replicate the input message along with the deterministic information and the sequence number to the backup server 64. The deterministic information is not particularly limited and can include information from various sources to preserve determinism when the primary server 62 is processing a plurality of input messages received from the client machine 54 and/or additional client machines (not shown). For example, the dispatcher 80 can communicate with resources that are external to the processing of the input message but resident on the primary server 62, such as a timestamp from CPU clock (not shown). As another example, the dispatcher 80 can communicate with resources that are external to the primary server 62, such as a market feed (not shown) that maintains up-to-date information of market prices for various securities identified in a buy order or a sell order received from the client machine 54. Furthermore, the assignment of the sequence number is not particularly limited and variations are contemplated. For example, the dispatcher 80 can obtain a sequence number from a counter within the primary server 62 or another type of assigned identifier. Alternatively, the sequence number can be non-sequential or substituted with a non-numerical identifier. Therefore, it is to be appreciated that any identifier configured to identify the input message can be used.

The verification engine 84 is generally configured to receive an output message from the trading engine 72 and to receive a confirmation message 200 from the backup server 64. The output message is not particularly limit and generally includes a result of processing the input message from the trading engine 72: For example, when the input message is an order to purchase a share, the output message from the trading engine 72 can indicate whether the share has been purchased or whether the order for the purchase the share was unable to be filled in accordance with parameters identified in the input message. Similarly, when the input message is an order to sell a share, the output message from the trading engine 72 can indicate whether the share has been sold or whether the order to sell the share was unable to be filled in accordance with parameters identified in the input message.

The verification engine 84 is generally further configured to send a verification message 205 to the backup server 64 and to send the output message to the session manager 76 for subsequently sending to the client machine 54. In the present embodiment, the verification engine 84 is further configured to receive a confirmation message 200 from the backup server 64 to confirm that the input message along with the deterministic information has been received at the backup server 64. Therefore, the verification engine 84 can withhold the output message if the conformation message is not received.

It is to be appreciated that the manner by which the verification engine 84 operates is not particularly limited. For example, the verification message 205 is also not particularly limited and generally configured to provide the backup server 64 with the results from the trading engine 72 for comparison with results obtained by processing the input message at the backup server 64. In the present embodiment, the verification message 205 is an identical copy of the output message. However, in other embodiments, the verification message 205 can include more or less information. In other embodiments, the verification message 205 can include the numerical results whereas the output message can include additional metadata.

As another example of a variation, in the present embodiment, the verification engine 84 receives a confirmation message 200 from the backup server 64 indicating that the input message and associated deterministic information has been received at the backup server 64. However, it is to be appreciated, with the benefit of this description, that the confirmation message 200 is optional. For example, other embodiments can operate without confirming that the backup server 64 has received the input message and associated deterministic information. It is to be understood that not receiving a confirmation message 200 can reduce the number of operations carried out by the system 50. However, if confirmation messages 200 are not use, the primary server 62 may not be aware of a failure of the backup server 64 or the direct connection 60 without another error checking mechanism in place.

In general terms, the gateway 68 is generally configured to handle input and output messages to the primary server 62. However, it is to be re-emphasized that the structure described above is a non-limiting representation. For example, although the present embodiment shown in FIG. 2 shows the session manager 76, the dispatcher 80 and the verification engine 84 as separate modules within the primary server 62, it is to be appreciated that modifications are contemplated and that several different configurations are within the scope of the invention. For example, the session manager 76, the dispatcher 80 and the verification engine 84 can be separate processes carried out in a single gateway application running on one or more processors or processor cores (not shown) of the primary server 62. Alternatively, the session manager 76, the dispatcher 80 and the verification engine 84 can be running on separate processors or processor cores. In yet another embodiment, the primary server 62 can be a plurality of separate computing devices where each of the session manager 76, the dispatcher 80 and the verification engine 84 can be running on separate computing devices.

The trading engine 72 is generally configured process the input message along with deterministic information to generate an output message. In the present embodiment, the trading engine 72 includes a plurality of trading engine components 88-1, 88-2, 88-3, 88-4, and 88-5 (also referred to as engine components in general). In the present embodiment, each trading engine component 88-1, 88-2, 88-3, 88-4, or 88-5 is configured to process a separate input message type associated with the specific trading engine component. For example, the trading engine component 88-1 can be configured to process input messages relating to a first group of securities, such as securities related to a specific industry sector or securities within a predetermined range of alphabetically sorted ticker symbols, whereas the trading engine component 88-2 can be configured to process input messages relating to a second group of securities. Those skilled in the art will now appreciate that various input messages can be processed in parallel using corresponding trading engine components 88-1, 88-2, 88-3, 88-4, and 88-5 to provide multi-threading, where several parallel threads of execution can occur simultaneously. Since the availability of each of the trading engine components 88-1, 88-2, 88-3, 88-4, and 88-5 can vary due to a number of conditions, the trading engine 72 can give rise to non-deterministic results such that the first input message received at the session manager 76 may not necessarily correspond to the first output message generated by the trading engine 72.

It is to be re-emphasized that the trading engine 72 described above is a non-limiting representation only. For example, although the present embodiment shown in FIG. 2 includes the trading engine 72 having trading engine components 88-1, 88-2, 88-3, 88-4, and 88-5, it is to be understood that the trading engine 72 can have more or less trading engine components. Furthermore, it is it is to be understood, with the benefit of this description, that trading engine components 88-1, 88-2, 88-3, 88-4, and 88-5 can be separate processes carried out by a single trading engine running on one or more shared processors or processor cores (not shown) of the primary server 62 or as separate processes carried out by separate processors or processor cores assigned to each trading engine components 88-1, 88-2, 88-3, 88-4, or 88-5. In yet another embodiment, the primary server 62 can be a plurality of separate computing devices where each of the trading engine components 88-1, 88-2, 88-3, 88-4, and 88-5 can be carried out on separate computing devices. As another example, the trading engine 72 can be modified to be a more general order processing engine for processing messages related to orders placed by a client. It is to be appreciated that in this alternative embodiment, the trading engine components 88-1, 88-2, 88-3, 88-4, or 88-5 are modified to be general engine components.

Similar to the primary server 62, the backup server 64 can be any type of computing device operable to receive and process input messages and deterministic information from the client machine 54. It is to be understood that the backup server 64 is not particularly limited to any machine and that several different types of computing devices are contemplated such as those contemplated for the primary server 62. The backup server 64 is configured to assume a primary role, normally assumed by the primary server 62, during a failover event and a backup role at other times. Accordingly, in the present example, the backup server 64 includes similar hardware and software as the primary server 62. However, in other embodiments, the backup server 64 can be a different type of computing device capable of carrying out similar operations. In the present embodiment, the backup server 64 includes a gateway 70 and a trading engine 74.

The type of input message being received and processed by the backup server 64 is not particularly limited. In a present embodiment, the backup server 64 is generally configured to operate in one of two roles: a backup role and a primary role. When the backup server 64 is operating in the backup role, the backup server 64 is configured to receive an input message, deterministic information, and a sequence number from the primary server 62. The backup server 64 then subsequently processes the input message using the deterministic information and the sequence number. For example, the input message can include an order to purchase or sell a share, or to cancel a previously placed order. It is to be appreciated that variations are contemplated. For example, the input received at the backup server 64 can include more or less data than the input message, the deterministic information and the sequence number. In particular, the sequence number can be omitted to conserve resources when the deterministic information is sufficient or when the sequence number is not needed.

When the backup server 64 is operating in the primary role, the backup server 64 is configured to carry out similar operations as the primary server 62 such as receive and process input messages from the client machine 54 directly. More particularly, in the present embodiment, the backup server 64 is configured switch between the primary role and the backup role dependent on whether a failover event exists.

The gateway 70 is similar to the gateway 68 and is generally configured to receive and to handle messages received from other devices, such as the client machine 54 and the primary server 62 as well as process and send messages to other devices such as the client machine 54 and the primary server 62. In the present embodiment, the gateway 70 includes a session manager 78, a dispatcher 82 and a verification engine 86.

The session manager 78 is generally inactive when the backup server 64 is operating in the backup role. During a failover event, the backup server 64 assumes a primary role and the session manager 78 can also assume an active role. In the primary role, the session manager 78 is configured to receive input messages directly from the client machine 54 via the network 58 and to send an output messages to the client machine 54 via the network 58. Similar to the session manager 76, it is to be understood that the manner by which the session manager 78 receives input messages is not particularly limited and a wide variety of different applications directed to on-line trading systems can be used.

When the backup server 64 is operating in the backup role, the dispatcher 82 is configured to receive the input message, the deterministic information, and the sequence number from the dispatcher 80 and to send a confirmation to the verification engine 84 of the primary server 62 in the present embodiment. When the backup server 64 is operating in the primary role, the dispatcher 82 is generally configured to carry out the similar operations as the dispatcher 80. In particular, the dispatcher 82 is configured to receive input messages from the client machine 54 and to communicate with various resources (not shown) to obtain deterministic information and to assign a sequence number when the backup server 64 is operating in the primary role. It is to be appreciated, with the benefit of this description, that in both roles, the dispatcher 82 is configured to obtain input messages along with the associated deterministic information and the associated sequence number and to dispatch or replicate the input messages along with the associated deterministic information and the associated sequence number to the trading engine 74.

The verification engine 86 is generally configured to receive a backup output message from the trading engine 74. Similar to the output message generated by the trading engine 72, the backup output message is not particularly limit and generally includes a result of processing the input message from the trading engine 74 in accordance with the deterministic information. For example, when the input message is an order to purchase a share, the output message from the trading engine 74 can indicate whether the share has been purchased or whether the order for the purchase the share was unable to be filled. Similarly, when the input message is an order to sell a share, the output message from the trading engine 74 can indicate whether the share has been sold or whether the order to sell the share was unable to be filled.

When the backup server 64 is operating in the backup role, the verification engine 86 is also generally configured to receive the verification message 205 from the verification engine 84 of the primary server 62. In the present embodiment, the verification engine 86 uses the verification message 205 to verify that the output message generated by the primary server 62 agrees with the backup output message generated by the trading engine 74. It is to be appreciated that the manner by which the verification engine 86 carries out the verification is not particularly limited. In the present embodiment, the verification message 205 received at the verification engine 86 is identical to the output message generated by the trading engine 72 of the primary server 62. Accordingly, the verification engine 86 carries out a direct comparison of the contents of the verification message 205 with the backup output message to verify the output message of the primary server 62, which in turn verifies that both the primary server 62 and the backup server 64 generate the same results from the same input message and deterministic information. In other embodiments, the verification message 205 can be modified to include more or less information than the output message. For example, the verification message 205 can include the numerical results whereas the output message can include additional metadata. As another example, the verification message 205 can be modified to be a hash function, a checksum, or some other validation scheme.

In general terms, the gateway 70 is generally configured to handle input and output messages to the backup server 64. However, it is to be re-emphasized that the structure described above is a non-limiting representation. For example, although the present embodiment shown in FIG. 2 shows the session manager 78, the dispatcher 82 and the verification engine 86 as separate modules within the backup server 64, it is to be appreciated that modifications are contemplated and that several different configurations are within the scope of the invention. For example, the session manager 78, the dispatcher 82 and the verification engine 86 can be separate processes carried out in a single gateway application running on one or more processors or processor cores (not shown) of the backup server 64. Alternatively, the session manager 78, the dispatcher 82 and the verification engine 86 can be running on separate processors or processor cores. In yet another embodiment, the backup server 64 can be a plurality of separate computing devices where each of the session manager 78, the dispatcher 82 and the verification engine 86 can be running on separate computing devices.

The trading engine 74 is generally configured to process the input message along with deterministic information to generate an output message. In the present embodiment, the trading engine 74 includes a plurality of trading engine components 90-1, 90-2, 90-3, 90-4, and 90-5 similar to the trading engine 72. In the present embodiment, each trading engine component 90-1, 90-2, 90-3, 90-4, and 90-5 is configured to process a separate input message type. It is to be appreciated that the input message types of the trading engine 74 can also be referred to as backup message types since they can be similar to the input message types of the trading engine 72 or different. For example, the trading engine component 90-1 can be configured to process input messages relating to a first group of securities, such as securities related to a specific industry sector or securities within a predetermined range of alphabetically sorted ticker symbols, whereas the trading engine component 90-2 can be configured to process input messages relating to a second group of securities. Input message types may be different types and thus configured to communicate different data. Those skilled in the art will now appreciate that various input messages can be processed in parallel using corresponding trading engine components 90-1, 90-2, 90-3, 90-4, and 90-5 to provide multi-threading, where several parallel threads of execution can occur simultaneously. Since the availability of each of the trading engine components 90-1, 90-2, 90-3, 90-4, and 90-5 can vary due to a number of conditions, the trading engine 74 can give rise to non-deterministic results such that the first input message received at the session manager 76 of the primary server 62, when the backup server 64 is operating in a backup role, may not necessarily correspond to the first output message generated by the trading engine 74.

It is to be re-emphasized that the trading engine 74 described above is a non-limiting representation only. For example, although the present embodiment shown in FIG. 2 includes the trading engine 74 having trading engine components 90-1, 90-2, 90-3, 90-4, and 90-5, it is to be understood that the trading engine 74 can have more or less trading engine components. Furthermore, it is it is to be understood, with the benefit of this description, that trading engine components 90-1, 90-2, 90-3, 90-4, and 90-5 can be separate processes carried out by a single trading engine running on one or more shared processors or processor cores (not shown) of the backup server 64 or as separate processes carried out by separate processors or processor cores assigned to each trading engine components 90-1, 90-2, 90-3, 90-4, or 90-5. In yet another embodiment, the backup server 64 can be a plurality of separate computing devices where each of the trading engine components 90-1, 90-2, 90-3, 90-4, and 90-5 can be carried out on a separate computing device.

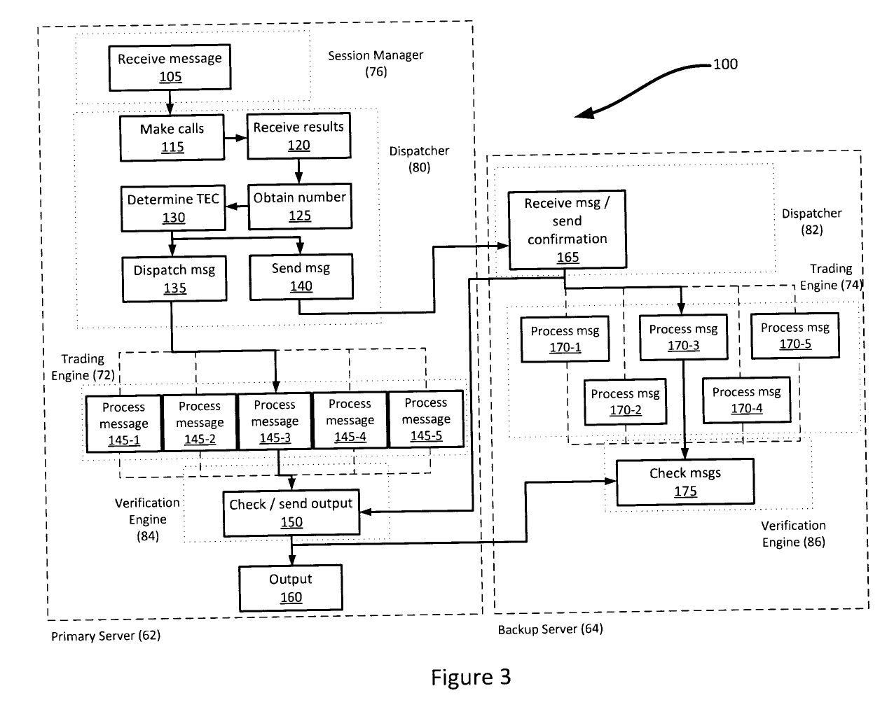

Referring now to FIG. 3, a flowchart depicting a method for processing orders when the backup server 64 is operating in the backup role is indicated generally at 100. In order to assist in the explanation of the method, it will be assumed that method 100 is carried out using system 50 as shown in FIG. 2. Furthermore, the following discussion of method 100 will lead to further understanding of system 50 and its various components. For convenience, various process blocks of method 100 are indicated in FIG. 3 as occurring within certain components of system 50. Such indications are not to be construed in a limiting sense. It is to be understood, however, that system 50 and/or method 100 can be varied, and need not work as discussed herein in conjunction with each other, and the blocks in method 100 need not be performed in the order as shown. For example, various blocks can be performed in parallel rather than in sequence. Such variations are within the scope of the present invention. Such variations also apply to other methods and system diagrams discussed herein.

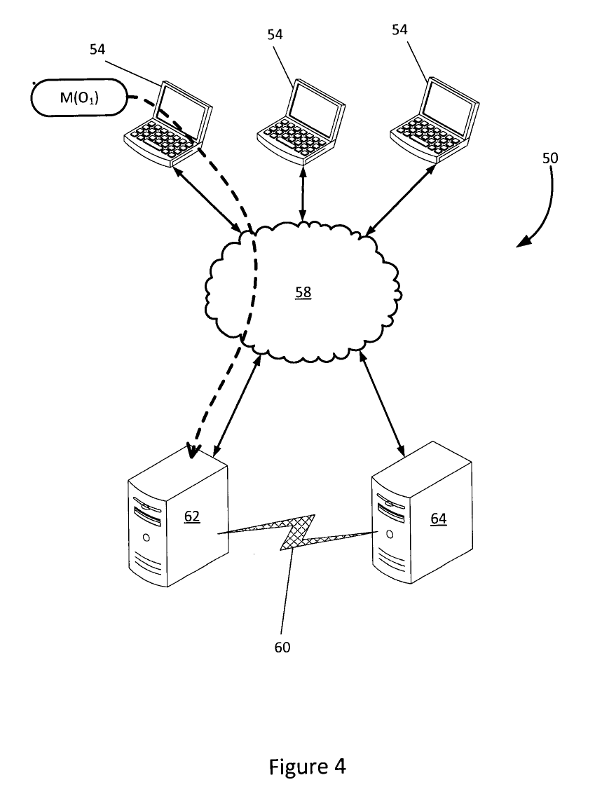

Block 105 comprises receiving an input message from the client machine 54. The type of input message is not particularly limited and is generally complementary to an expected type of input message for a service executing on the primary server 62. In the present embodiment, the input message can be a “buy order”, “sell order”, or “cancel order” for a share. Table I below provides an example of contents of an input message M(O₁) having four fields received from the client machine 54 to buy shares. This exemplary performance of block 105 is shown in FIG. 4, as an input message M(O₁) is shown as originating from client machine 54 and received at the primary server 62.

TABLE I
Message M(O₁)

| Field | Field | Example |
|---|---|---|
| Number | Name | Contents |
| 1 | Trader | Trader T-1 |
| 2 | Security Name | ABC Co. |
| 3 | Transaction | Buy |
| | Type | |
| 4 | Quantity | 1,000 units |

It is to be emphasized that the input message M(O₁) of Table I is a non-limiting representation for illustrative purposes only. For example, although the input message M(O₁) contains four fields as shown in Table I, it is to be understood that the input message M(O₁) can include more or less fields. Furthermore, it is also to be understood that the information in the input message M(O₁) is not particularly limited and that the input message M(O₁) can include more or less data dependent on the characteristics of the system 50. In addition, the input message M(O₁) need not be of a specific format and that various formats are contemplated. For example, in some embodiments, the primary server 62 can be configured to receive input messages, each having a different format. However, the example contents of Table I will be referred to hereafter to further the explanation of the present example.

Block 115 comprises making a call for external data associated with the input message M(O₁) from the dispatcher 80. The external data is not particularly limited and can be utilized to further process the input message M(O₁). In the present embodiment, the external data includes deterministic information that can be used to preserve determinism when processing the input message M(O₁) on the primary server 62 and the backup server 64. The external data can include data received from services external to the system 50. For example, external data can include market feed data, banking data, or other third party data. Furthermore, it is to be appreciated, with the benefit of this description, that the external data does not necessarily require the data to originate from outside of the system 50. For example, the external data can also include a timestamp originating from one of the primary server 62 or the backup server 64.

In the present embodiment the dispatcher 80 makes an external call for a timestamp associated with the receipt of the input message M(O₁) at the session manager 76 and a current market price for the security identified in field 2 of the order in message M(O₁). The external call for a timestamp is sent to the CPU clock (not shown) of the primary server 62. The external call for a market price is sent to an external market feed service (not shown).

Block 120 comprises receiving, at the dispatcher 80, the result of the call from the operation of block 115. In the present embodiment the dispatcher 80 receives the timestamp associated with the receipt of the input message M(O₁) from the CPU clock of the primary server 62 and a current market price for the security identified in field 2 of the order in message M(O₁) from the external market feed service.

It is to be appreciated, with the benefit of this description, that the call for external data inherently renders the system 50 non-deterministic when carried out by the primary server 62 and the backup server 64 in parallel. Continuing with the present example where a call is made for a timestamp and a current market price, the non-deterministic nature naturally arises from the race conditions inherent to the system 50.

For example, the exact moment when the input message is received and the moment when the call is made for a timestamp is critical in order to ensure market fairness. It is unlikely that the primary server 62 and the backup server 64 can make a call for a timestamp at precisely the same time due to minor differences between the primary server 62 and the backup server 64 as well as synchronizing tolerances and lags introduced by communication between the primary server 62 and the backup server. Therefore, the primary server 62 and the backup server 64 can assign a different timestamp, resulting in potential differing outcomes.

Likewise, the exact moment when the input message is received and the call is made for a market price is also critical in order to ensure market fairness. This is especially true for securities trading with low volume or liquidity and where an order can significantly affect the price or availability of the share. Similar to the call for a timestamp, it is unlikely that that the primary server 62 and the backup server 64 make a call for a market price at exactly the same time. Therefore, that the primary server 62 and the backup server 64 can potentially have different market prices for the input message from the client machine 54. Accordingly, during a failover event, that the primary server 62 and the backup server 64 may not have consistent market data due to this non-deterministic nature.

Block 125 comprises using the dispatcher 80 for obtaining a sequence number associated with the input message M(O₁). The manner by which the sequence number is obtained is not particularly limited and can involve making a call, similar to the operation of block 115, to an external counter. Alternatively, the dispatcher 80 can include an internal counter and assign a sequence number to the input message M(O₁).

Block 130 comprises determining, at the dispatcher 80, to which of the plurality of trading engine components 88-1, 88-2, 88-3, 88-4, and 88-5 the input message M(O₁), the associated deterministic information, and the associated sequence number are to be dispatched for processing. The manner by which the determination is made is not particularly limited and can involve performing various operations at the dispatcher 80. For example, if the plurality of trading engine components 88-1, 88-2, 88-3, 88-4, and 88-5 are configured to process a specific type of input message, the dispatcher 80 can determine which type of input message the input message M(O₁) is and make the appropriate determination. For example, this determination can be made using the value stored in Field 2 of Table 1 and performing a comparison with lookup tables stored in a memory of the primary server 62. In other embodiments, the dispatcher 80 can make the determination dependent on the trading engine component 88-1, 88-2, 88-3, 88-4, or 88-5 having the highest availability. In other embodiments still, the method 100 can be modified such that the determination can be carried out by another device or process separate from the dispatcher 80 to reduce the demand of resources at the dispatcher 80.

In the present example, the dispatcher 80 has determined that the input message M(O₁) is to be processed using the trading engine component 88-3. After determining which of the trading engine components 88-1, 88-2, 88-3, 88-4, and 88-5, the method 100 moves on to blocks 135 and 140.

Those skilled in the art will now appreciate that as various input messages are processed using a corresponding trading engine components 88-1, 88-2, 88-3, 88-4, and 88-5 to provide multi-threading, where several parallel threads of execution can occur simultaneously to introduce further non-determinism into the system 50. For example, the availability of each trading engine components 88-1, 88-2, 88-3, 88-4, and 88-5 can vary due to a number of conditions such that the trading engine 72 can give rise to non-deterministic results. As another example, each of the trading engine components 88-1, 88-2, 88-3, 88-4, and 88-5 can be inherently slower as a result of the type of input message received at the specific trading engine component 88-1, 88-2, 88-3, 88-4, or 88-5. Accordingly, it is to be appreciated, with the benefit of this description, that the first input message received at the session manager 76 may not necessarily correspond to the first output message generated by the trading engine 72.

Block 135 comprises dispatching the input message M(O₁), the associated deterministic information, and the associated sequence number from the dispatcher 80 to the trading engine 72. In the present embodiment, the deterministic information and the sequence number are also dispatched. The manner by which the input message M(O₁), the deterministic information, and the sequence number are dispatched is not particularly limited and can involve various manners by which messages are transmitted between various components or processes of the primary server 62. In the present embodiment, a plurality of trading engine component processes 145-1, 145-2, 145-3, 145-4, and 145-5 are carried out by the plurality of trading engine components 88-1, 88-2, 88-3, 88-4, and 88-5, respectively. Since the input message M(O₁) of the present example was determined at block 130 to be processed by the trading engine component 88-3, the input message M(O₁), the deterministic information, and the sequence number cause the method 100 to advance to block 145-3.

Table II shows exemplary data dispatched from the dispatcher 80 to the trading engine 72 associated with the input message M(O₁):

TABLE II
Exemplary Data Dispatched in Block 135

| Record | Field | Field | Example |
|---|---|---|---|
| Number | Number | Name | Contents |
| 1 | 1 | Message | M(O₁) |
| 1 | 2 | Timestamp | 12:00PM, |
| | | | Jan. 5, 2000 |
| 1 | 3 | Market Price | $2.00 |
| 1 | 4 | Sequence | 1 |
| | | Number | |
| 1 | 5 | Trading Engine | 88-3 |
| | | Component | |

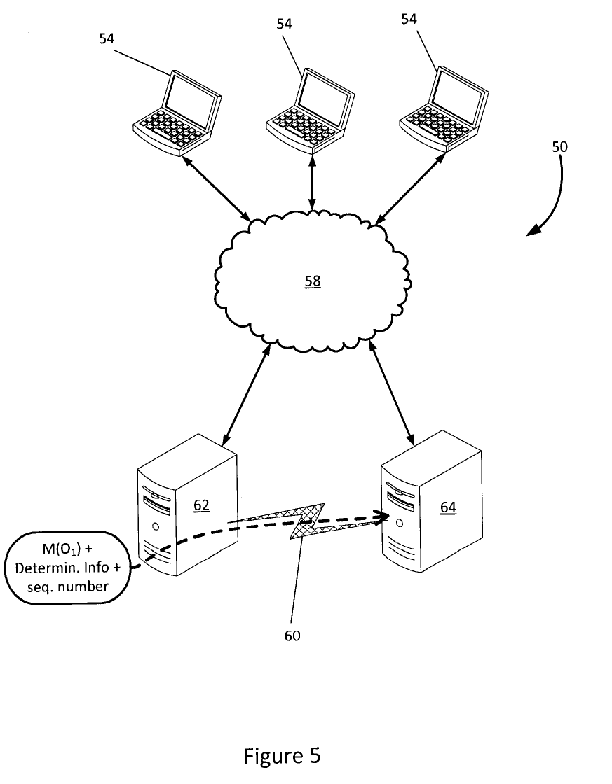

Block 140 comprises dispatching or replicating the input message M(O₁), the deterministic information, and the sequence number from the dispatcher 80 to the backup server 64. The manner by which the input message M(O₁), the deterministic information, and the sequence number are dispatched or replicated is not particularly limited and can involve various manners by which messages are transmitted between servers. In the present embodiment, the data is dispatched or replicated via the direct connection 60. This exemplary performance of block 140 is shown in FIG. 5, as an input message M(O₁), the deterministic information, and the sequence number is shown as originating from the primary server 62 and received at the backup server 64 via the direct connection 60.

Table III shows exemplary data dispatched or replicated from the dispatcher 80 to the backup server 64 associated with the input message M(O₁):

TABLE III
Exemplary Data Dispatched or Replicated in Block 140

| Record | Field | Field | Example |
|---|---|---|---|
| Number | Number | Name | Contents |
| 1 | 1 | Message | M(O₁) |
| 1 | 2 | Timestamp | 12:00PM, |
| | | | Jan. 5, 2000 |
| 1 | 3 | Market Price | $2.00 |
| 1 | 4 | Sequence | 1 |
| | | Number | |
| 1 | 5 | Trading Engine | 88-3 |
| | | Component | |

Although the entire message M(O₁) along with the deterministic information and the sequence number is dispatched or replicated to the backup server 64 in the present embodiment as shown in Table III, variations are contemplated. In other embodiments, the input message M(O₁) can contain more or less information. For example, the value stored in Field Number 1 of Table I can be omitted. As another example, the input message M(O₁) can include further data associated with the data transfer itself such as an additional timestamp or status flag. Furthermore, the result of the determination made in block 130 can be omitted from being sent to the backup server. However, it is to be appreciated, with the benefit of this description, that in embodiments where the determination is not sent, a similar determination can be made at the backup server 64.

Blocks 145-1, 145-2, 145-3, 145-4, and 145-5 comprise processing a message at the trading engine components 88-1, 88-2, 88-3, 88-4, and 88-5, respectively. In the present example of the input message M(O₁), block 145-3 is carried out by the trading engine component 88-3 to process the order for 1000 shares of ABC Co. Block 145-3 is carried out using an order placement service where a buy order is generated on the market. After carrying out the operations of block 145-3, the trading engine component 88-3 generates an output message for sending to the verification engine 84 and advances to block 150.

Block 150 comprises sending a verification message 205 from the verification engine 84 to the backup server 64 and sending the output message to the session manager 76 for ultimately sending back to the client machine 54 from which the input message M(O₁) was received. The verification message 205 is not particularly limited and will be discussed further below in connection with the verification engine 86 of the backup server. This exemplary performance of block 150 is shown in FIG. 5, as verification message 205 is shown as originating from the primary server 62 and received at the backup server 64 via the direct connection 60.

In the present embodiment, block 150 further comprises checking that a confirmation message 200 associated with the input message M(O₁) has been received from the backup server 64. It is to be appreciated, with the benefit of this description, that this optional confirmation message 200 provides an additional mechanism to ensure that the backup server is operating normally to receive the input message M(O₁). Therefore, in the present embodiment, block 150 will wait until the confirmation message 200 has been received before sending the output message to the session manager 76. However, in other embodiments, block 150 can be modified such that the verification engine 84 need not actually wait for the confirmation message 200 before proceeding on to block 160. It is to be appreciated that in embodiments where block 150 need not wait for the confirmation message 200, block 150 can still expect a confirmation message 200 such that if no confirmation message 200 is received within a predetermined period of time, the primary server 62 becomes alerted to a failure of the backup server 64. In another embodiment, it is to be appreciated that the confirmation message 200 can be omitted to reduce the amount of resources required at the primary server 62 as well as the amount of data sent between the primary server 62 and the backup server 64.

Block 160 comprises sending the output message from the session manager 76 back to the client machine 54 from which the input message M(O₁) originated. The manner by which the output message is sent is not particularly limited and can include using similar communication methods used to receive the input message M(O₁). For example, the session manager need not send the output message to the client machine 54 and can instead send the output message to another device.

Referring again to FIG. 3, blocks 170-1, 170-2, 170-3, 170-4, and 170-5 are generally inactive when the backup server 64 is operating in the backup role. Blocks 170-1, 170-2, 170-3, 170-4, and 170-5 carry out similar functions to blocks 145-1, 145-2, 145-3, 145-4, and 145-5, respectively, as described above when the backup server 64 is operating in the primary role.

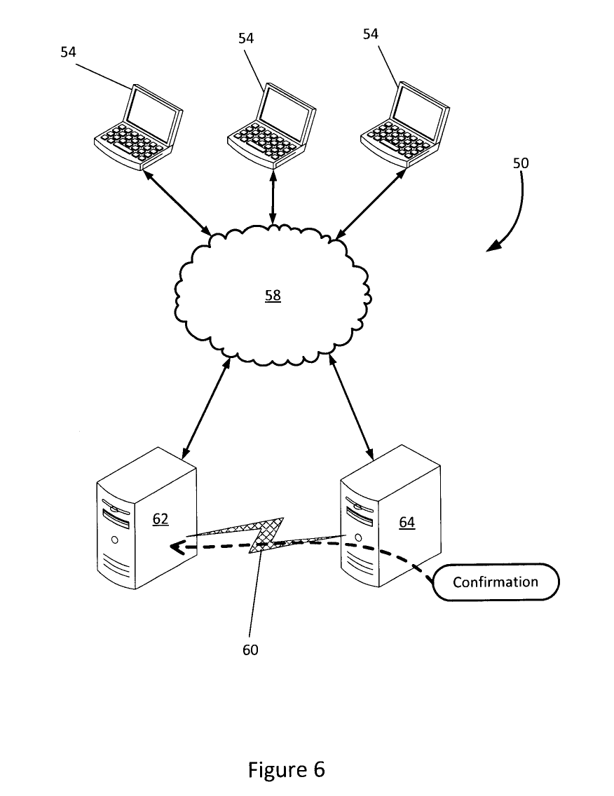

Block 165 comprises receiving the input message M(O₁), the deterministic information, and the sequence number at the dispatcher 82 of the backup server 64 from the dispatcher 80 of the primary server 62. Continuing with the example above, block 165 also optionally receives the determination made at block 130 in the present embodiment. Furthermore, block 165 also optionally sends a confirmation message 200 from the dispatcher 82 back to primary server 62 to indicate that the input message M(O₁), the deterministic information, and/or the sequence number have been safely received at the backup server. This optional performance of block 165 involving sending the confirmation message 200 is shown in FIG. 6, as the confirmation message 200 is shown as originating from the backup server 64 and received at the primary server 62 via the direct connection 60. It is to be appreciated, with the benefit of this description, that the primary server 62 and the backup server 64 are similar such that the determination made at block 130 can be applied to both the primary server 62 and the backup server 64. In other embodiments where the primary server 62 and the backup server 64 cannot use the same determination made at block 130, a separate determination can be carried out.

Block 165 comprises dispatching or replicating the input message M(O₁), the deterministic information, and the sequence number from the dispatcher 82 to the trading engine 74. The manner by which the data chunk is sent is not particularly limited and can include similar methods as those described above in block 135. In particular, the data dispatched or replicated can be the same data as shown in Table II.

Blocks 170-1, 170-2, 170-3, 170-4, and 170-5 each comprise processing a message at the trading engine components 90-1, 90-2, 90-3, 90-4, and 90-5, respectively. In the present embodiment, the primary server 62 and the backup server are structurally equivalent. Accordingly, blocks 170-1, 170-2, 170-3, 170-4, and 170-5 carry out the same operations as blocks 145-1, 145-2, 145-3, 145-4, and 145-5, respectively. Therefore, in the present example of the input message M(O₁), block 170-3 is used to process the input message M(O₁) and is carried out by the trading engine component 90-3 to process the order for 1000 shares of ABC Co. The manner in which the input message M(O₁) is processed is not particularly limited and can include similar methods as those described above in block 145-3. After carrying out the operations of block 170-3, the trading engine component 90-3 generates an output message for sending to the verification engine 86 and advances to block 175.

Block 175 comprises receiving and comparing the verification message 205 from the primary server 62 at the verification engine 86. Continuing with the present example of the present embodiment, block 175 compares the verification message 205 from the primary server 62 with the output message generated at block 170-3. The manner by which the verification message 205 is compare with the output message generated at block 170-3 is not particularly limited and can include various checksum or validation operations to verify the integrity results when processed independently by the primary server 62 and the backup server 64. For example, in the present embodiment, the verification message 205 can be a copy of the output message generated by the trading engine 72. The verification engine 86 can then carry out a direct comparison between the verification message 205 and the output message generated by the trading engine 74. In other embodiments, less data can be included in the verification message 205 to conserve resources.

It is to be re-emphasized that the method 100 described above is a non-limiting representation. For example, the variants discussed above can be combined with other variants.

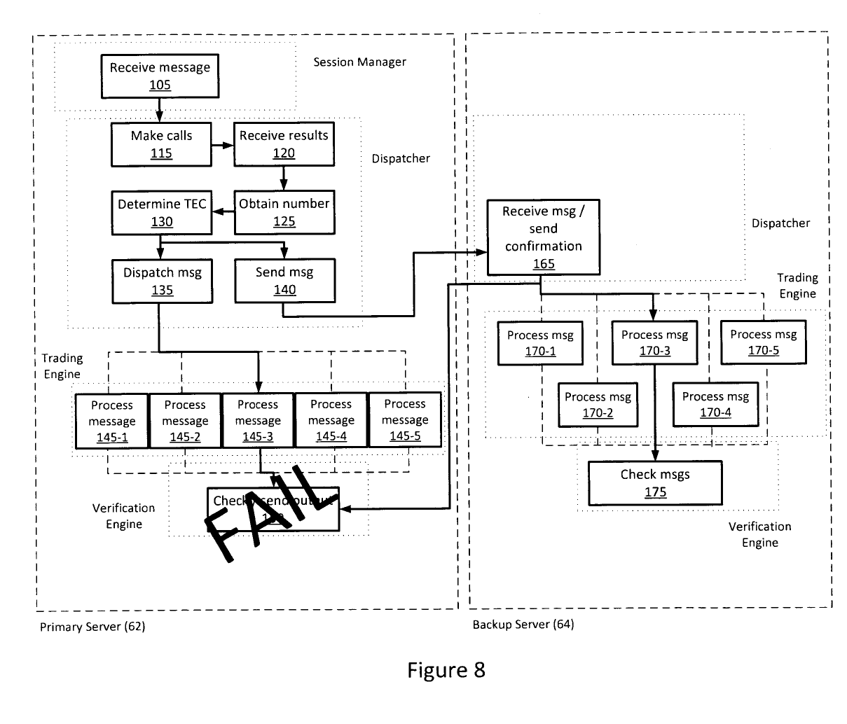

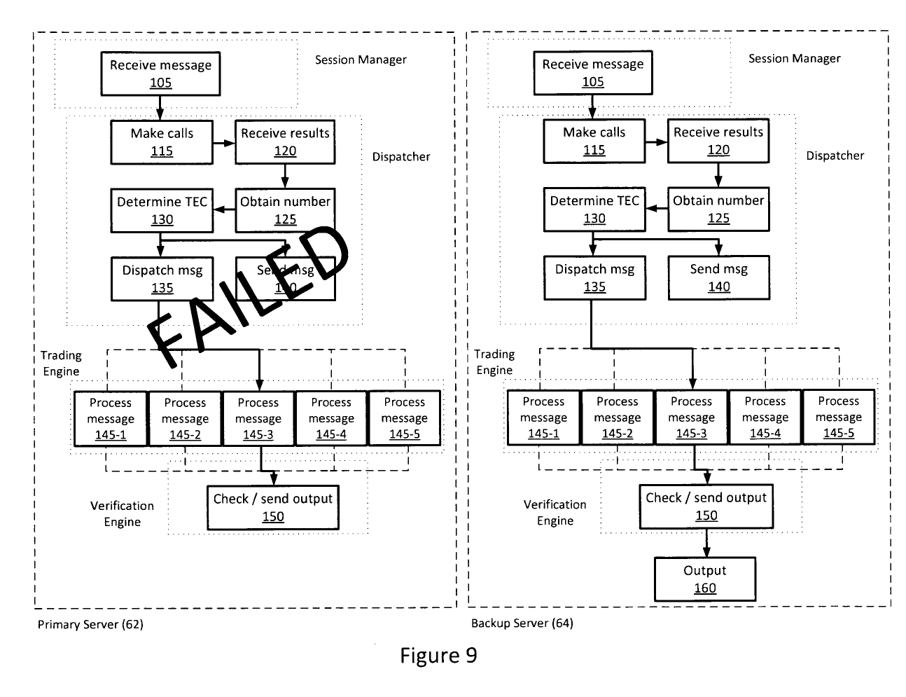

Referring to FIG. 8, an exemplary failure of the verification engine 84 of the primary server 62 is shown. The exemplary failure prevents block 160 from being executed and thus the backup server 64 fails to receive the verification message 205 from the primary server 62. Upon recognizing that the primary server 62 has experienced a failure, the backup server 64 switched from operating in the backup role to operating in the primary role as shown in FIG. 9. The manner by which the backup server 64 switches from the backup role to the primary role is not particularly limited. For example, the primary server 62 and the backup server 64 can each include stored instructions to carry out a failover protocol operating in the verification engines 84 and 86, respectively.

The failover protocol of the primary server 62 can communicate with the failover protocol of the backup server 64 monitor the system 50 for failures. The failover protocol can use the results of the comparison carried out in block 175 as an indicator of the system 50. It is to be appreciated, with the benefit of this description, that a failure need not necessarily occur in the primary server 62 and that a wide variety of failures can affect the performance of the system 50. For example, a failure in the direct connection 60 between the primary server 62 and the backup server 64 and a failure of the communication hardware in the backup server 64 can also disrupt the verification message 205. Therefore, in other embodiments, the failover protocol can be configured to detect the type of failure to determine whether the backup server 64 is to be switched to a primary role. In further embodiments, the failover protocol can also include communicating period status check messages between the primary server 62 and the backup server 64.

The manner by which the backup server switches from the backup mode to the primary mode is not particularly limited. In the present embodiment, the backup server 64 activates the session manager 78 and sends a message to the client machine 54 to inform the client machine 54 that the backup server 64 has switched to a primary role such that future input messages are received at the session manager 78 instead of the session manager 76. In addition, the dispatcher 82 activates processes of blocks 170-1, 170-2, 170-3, 170-4, and 170-5. In other embodiments, an external relay can be used to communicate with the client machine 54 and automatically direct the input message to the correct server without informing the client machine 54 that a failover event has occurred.

Furthermore, it is to be appreciated that in the event the primary server 62 fails, the failover protocol can request an input message to be resent from the client machine 54. If the dispatcher 80 of the primary server 62 experiences a failure prior to carrying out the operation of block 140, the input message can be lost. Accordingly, the failover protocol can be generally configured to request at least some of the input messages be resent. Therefore, the backup server 64 can receive a duplicate input message from the client machine 54 when switching from the backup role to the primary role. For example, if the backup server is processing the input message M(O₁) and the client machine re-sends the input message M(O₁) due to the failover event, the backup server 64 can process the same input message twice. It is to be appreciated that the potential duplicate message can be handled using an optional gap recovery protocol to reduce redundancy.

The gap recovery protocol is generally configured to recognize duplicate messages and simply return the same response if already processed at the backup server 64, without attempting to reprocess the same message. The exact manner by which the gap recovery protocol is configured is not particularly limited. For example, the gap recovery protocol can compare the fields of the input message to determine if a similar input message were to be received from the primary server 62. In the event the input message and deterministic information was received from the primary server 62, the gap recovery protocol will use the output message generated by the trading engine 74. In the event that the input message was not received from the primary server 62, the backup server 64 follows the method shown in FIG. 9 to process the message.

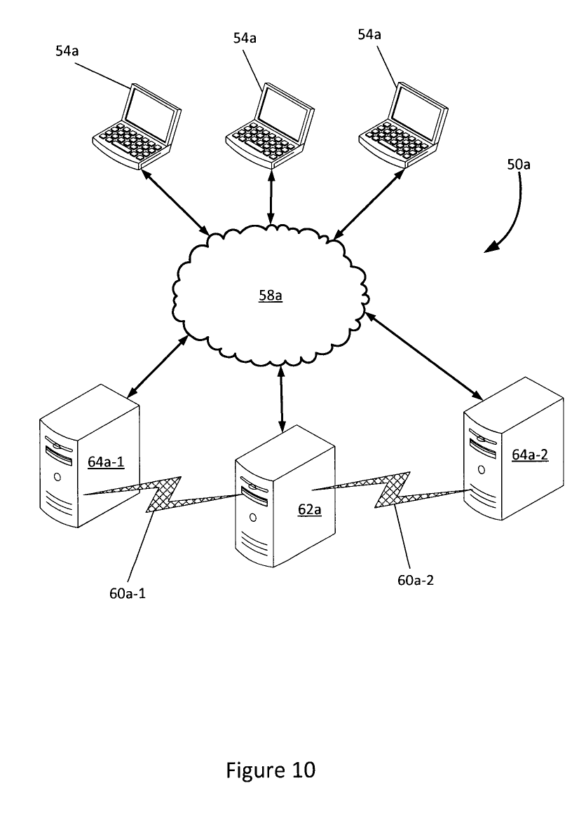

Referring to FIG. 10, another embodiment of a system for failover is indicated generally at 50a. Like components of the system 50a bear like reference to their counterparts in the system 50, except followed by the suffix “a”. The system 50a includes a client machine 54a connected to a network 58a. The network 58a is connected to a primary server 62a, a first backup server 64a-1 and a second backup server 64a-2. Accordingly, the client machine 54a can communicate with primary server 62a and/or the backup servers 64a-1 and 64a-2 via the network 58a.

In the present embodiment, the primary server 62a communicates with both the backup servers 64a-1 and 64a-2 as shown in FIG. 10 via direct connections 60a-1 and 60a-2. The input message, the deterministic information, and the sequence number from the dispatcher 80a to both backup servers 64a-1 and 64a-2. Similarly, the verification message 205 is also sent to both backup servers 64a-1 and 64a-2. It is to be appreciated that in the event of a failure of the primary server 62a, one of the backup servers 64a-1 and 64a-2 can switch from operating in a backup role to operating in a primary role. It is to be appreciated, with the benefit of this description, that when the primary server 62a fails and one of the backup servers 64a-1 and 64a-2 switches to the primary role, the system 50a effectively switches to a system similar to the system 50.

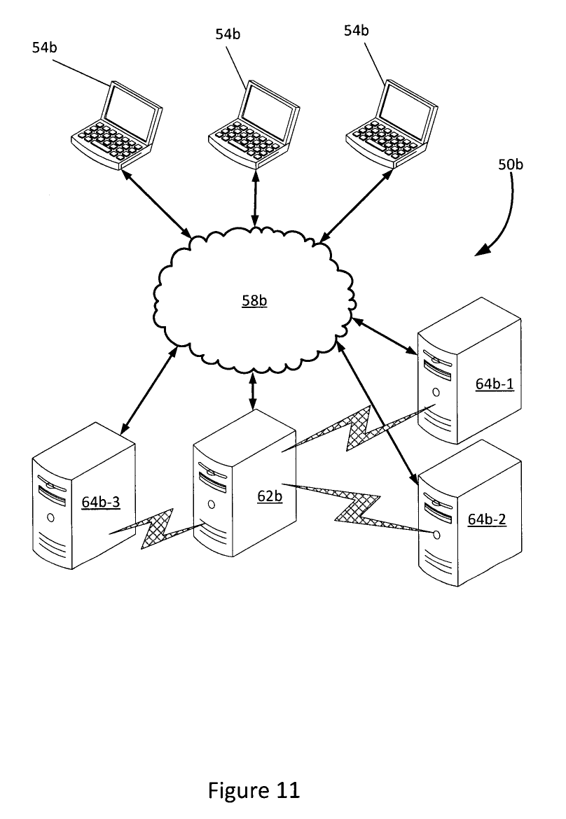

Referring to FIG. 11, embodiment of a system for failover is indicated generally at 50b. Like components of the system 50b bear like reference to their counterparts in the system 50, except followed by the suffix “b”. The system 50b includes a client machine 54b connected to a network 58b. The network 58b is connected to a primary server 62b, a first backup server 64b-1, a second backup server 64b-2, and a third backup server 64b-3. Accordingly, the client machine 54b can communicate with primary server 62b and/or the backup servers 64b-1, 64b-2, and 64b-3 via the network 58b.

It is to be appreciated that when verification messages 205 are send to a plurality of backup servers for comparison, the results of the comparison can be further compared. For example, a failover protocol can require unanimous results among the plurality of backup servers 64b-1, 64b-2, and 64b-3 before determining that a failure has occurred. Alternatively, the failover protocol can require a majority of the results among the plurality of backup servers 64b-1, 64b-2, and 64b-3 before determining that a failure has occurred

Variations are contemplated. For example, although the present embodiment shown in FIG. 10 includes three backup servers 64b-1, 64b-2, and 64b-3, the system 50b can include more or less than three servers. It is to be appreciated that by adding more server to the system 50b, the amount of redundancy and failover protection increases. However, each additional server increases the complexity and resources for operating the failover system.

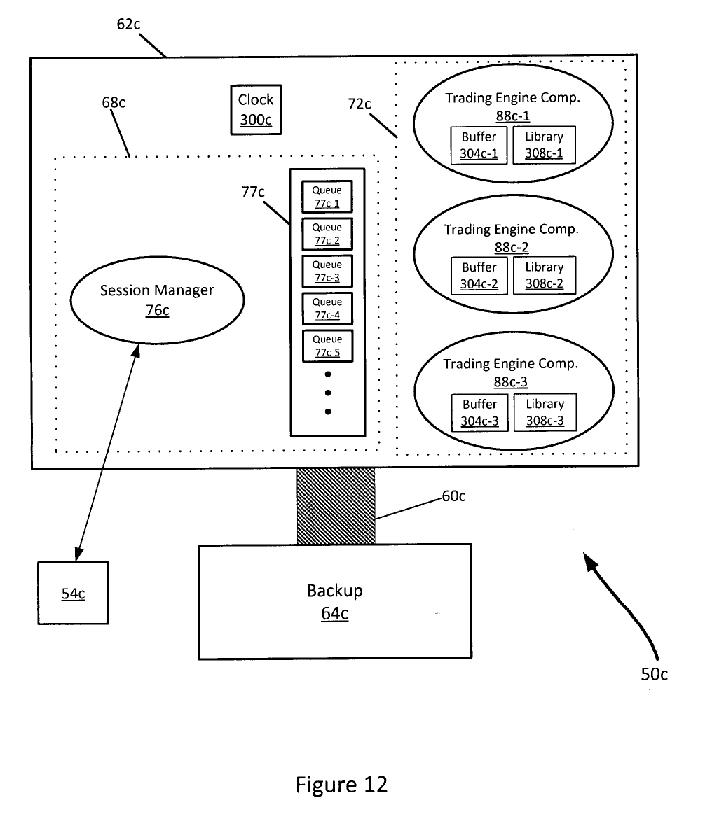

Referring to FIG. 12, a schematic block diagram of another embodiment of a system for failover is indicated generally at 50c. Like components of the system 50c bear like reference to their counterparts in the system 50, except followed by the suffix “c”. The system 50c includes a client machine 54c, a primary server 62c, and a backup server 64c. In the present embodiment, a direct connection 60c connects the primary server 62c and the backup server 64c. The direct connection 60c is not particularly limited and can include various types of connections including those discuss above in connection with other embodiments.

In the present embodiment, the primary server 62c can be any type of computing device operable to receive and process input messages from the client machine 54c, such as those discussed above in connection with other embodiments. Similar to the primary server 62, the primary server 62c of the present embodiment operates as an on-line trading system, and is thus able to process input messages that include orders related to securities that can be traded on-line. For example, the orders can include an order to purchase or sell a share, or to cancel a previously placed order. More particularly in the present embodiment, the primary server 62c is configured to execute orders received from the client machine 54c. The primary server 62c includes a gateway 68c, an order processing engine 72c, and a clock 300c.

Similar to the embodiment described above, the gateway 68c is generally configured to receive and to handle messages received from other devices, such as the client machine 54c as well as process and send messages to other devices such as the client machine 54c in communication with the primary server 62c. In the present embodiment, the gateway 68c includes a session manager 76c, and a memory storage 77c.

The session manager 76c is generally configured to receive an input message from the client machine 54c via a network and to send an output message to the client machine 54c via the network. It is to be understood that the manner by which the session manager 76c receives input messages is not particularly limited and a wide variety of different applications directed to on-line trading systems can be used.

The memory storage 77c is generally configured to maintain a plurality of queues 77c-1, 77c-2, 77c-3, 77c-4, and 77c-5. In the present embodiment, the plurality of queues 77c-1, 77c-2, 77c-3, 77c-4, and 77c-5 are generally configured to queue pointers to messages that are to be sent to the order processing engine 72c for processing. It is to be understood, with the benefit of this description, that a component of the order processing engine 72c may be occupied processing a message. Accordingly, the input message is stored in the memory storage 77c until the order processing engine 72c can accept the input message.

It is to be re-emphasized that the memory storage 77c described herein is a non-limiting representation. For example, although the present embodiment shown in FIG. 12 includes the memory storage 77c having the plurality of queues 77c-1, 77c-2, 77c-3, 77c-4, and 77c-5, it is to be understood that the memory storage 77c can include more or less queues. Furthermore, it is it is to be understood, with the benefit of this description, that the plurality of queues 77c-1, 77c-2, 77c-3, 77c-4, and 77c-5 can be physically located on different memory storage devices or can be store on different portions of the same memory device. Furthermore, it is to be appreciated, with the benefit of this description that in some embodiments, each of the queues in the plurality of queues 77c-1, 77c-2, 77c-3, 77c-4, and 77c-5 can be associated with a specific message type, for example, a message representing an order for a specific security or group of securities. In other embodiments, the plurality of queues 77c-1, 77c-2, 77c-3, 77c-4, and 77c-5 can be associated with a specific component or group of components of the order processing engine 72c. In yet another embodiment, the plurality of queues 77c-1, 77c-2, 77c-3, 77c-4, and 77c-5 can be used and assigned based on a load balancing algorithm.

In general terms, the gateway 68c is generally configured to handle input and output messages to the primary server 62c. However, it is to be re-emphasized that the structure described in the present embodiment is a non-limiting representation. For example, although the present embodiment shown in FIG. 12 shows the session manager 76c and the memory storage 77c as separate modules within the primary server 62c, it is to be appreciated that modifications are contemplated and that several different configurations are within the scope of the invention. For example, the session manager 76c and the memory storage 77c can be managed on a single processor core or the can be managed by a plurality of processor cores within the primary server 62c. In yet another embodiment, the primary server 62c can be a plurality of separate computing devices where the session manager 76c, and the memory storage 77c can operate on the separate computing devices.

In the present embodiment, the order processing engine 72c is generally configured to process an input message along with obtaining and processing deterministic information to generate an output message. In the present embodiment, the order processing engine 72c includes a plurality of engine components 88c-1, 88c-2, and 88c-3. Each of the engine components 88c-1, 88c-2, and 88c-3 includes a buffer 304c-1, 304c-2, and 304c-3, respectively, and a library 308c-1, 308c-2, and 308c-3, respectively. The engine components 88c-1, 88c-2, and 88c-3 are each configured to receive an input message from a queue of the plurality of queues 77c-1, 77c-2, 77c-3, 77c-4, and 77c-5 and to process the input message. In the present embodiment each of the engine components 88c-1, 88c-2, and 88c-3 is further configured to process a separate input message type associated with the specific engine component 88c-1, 88c-2, and 88c-3. It is to be appreciated, with the benefit of this description, that the type of input message associated with the specific engine component 88c-1, 88c-2, and 88c-3 does not necessarily involve the same grouping as discussed above in connection with the memory storage 77c. For example, the engine component 88c-1 can be configured to process input messages relating to a first group of securities, such as securities related to a specific industry sector or securities within a predetermined range of alphabetically sorted ticker symbols, whereas the engine component 88c-2 can be configured to process input messages relating to a second group of securities. Those skilled in the art will now appreciate that various input messages can be processed in parallel using corresponding engine components 88c-1, 88c-2, and 88c-3 to provide multi-threading, where several parallel threads of execution can occur simultaneously. Since the availability of each of the engine components 88c-1, 88c-2, and 88c-3 can vary due to a number of conditions, the order processing engine 72c can give rise to non-deterministic results such that the first input message received at the session manager 76c may not necessarily correspond to the first output message generated by the order processing engine 72c unless further deterministic information is considered.

Accordingly, each of the engine components 88c-1, 88c-2, and 88c-3 processes deterministic information with each input message in order to maintain determinism. For example, in the present embodiment, the engine components 88c-1, 88c-2, and 88c-3 obtain a sequence number from the library 308c-1, 308c-2, and 308c-3, respectively, when processing the input message. It is to be appreciated, with the benefit of this description, that the sequence number provided by each library 308c-1, 308c-2, and 308c-3 can be used to maintain determinism of the system 50c.

It is to be re-emphasized that the order processing engine 72c described above is a non-limiting representation only. For example, although the present embodiment shown in FIG. 12 includes the order processing engine 72c having engine components 88c-1. 88c-2, and 88c-3, it is to be understood that the order processing engine 72c can have more or less engine components. Furthermore, it is it is to be understood, with the benefit of this description, that engine components 88c-1, 88c-2, and 88c-3 can be separate threads of execution carried out by a single order processing engine running on one or more shared processor cores (not shown) of the primary server 62c or as separate threads of execution carried out by separate processor cores assigned to each engine components 88c-1, 88c-2, and 88c-3. In yet another embodiment, the primary server 62c can be a plurality of separate computing devices where each of the engine components 88c-1, 88c-2, and 88c-3 can be carried out on separate computing devices.

The clock 300c is generally configured to measure time and to provide a timestamp when requested. The manner by which the clock 300c measures time is not particularly limited and can include a wide variety of mechanisms for measuring time. Furthermore, the manner by which a timestamp is provided is not particularly limited. In the present embodiment, timestamp is obtained by reading a variable local to the application process that is updated by the clock 300c.

It is to be appreciated that the manner by which the timestamp is obtained is not particularly limited. For example, the clock 300c can be modified to be another process configured to receive a call message from a component of the order processing engine 72c requesting a timestamp. In response, a timestamp message can be returned to the component of the order processing engine 72c that requested the timestamp. In other embodiments, the clock 300c can also be modified to provide a continuous stream of timestamp messages to the order processing engine 72c.

Similar to the primary server 62c, the backup server 64c can be any type of computing device operable to receive and process input messages and deterministic information from the client machine 54c. It is to be understood that the backup server 64c is not particularly limited to any machine and that several different types of computing devices are contemplated such as those contemplated for the primary server 62c. The backup server 64c is configured to assume a primary role, normally assumed by the primary server 62c, during a failover event and a backup role at other times. Although the schematic block diagram of FIG. 12 shows the primary server 62c and the backup server 64c having two different sizes, it is to be understood that the schematic block diagram is intended to show the internal components of the primary server 62c. Accordingly, in the present embodiment, the backup server 64c includes similar hardware and software as the primary server 62c. However, in other embodiments, the backup server 64c can be a different type of computing device capable of carrying out similar operations.

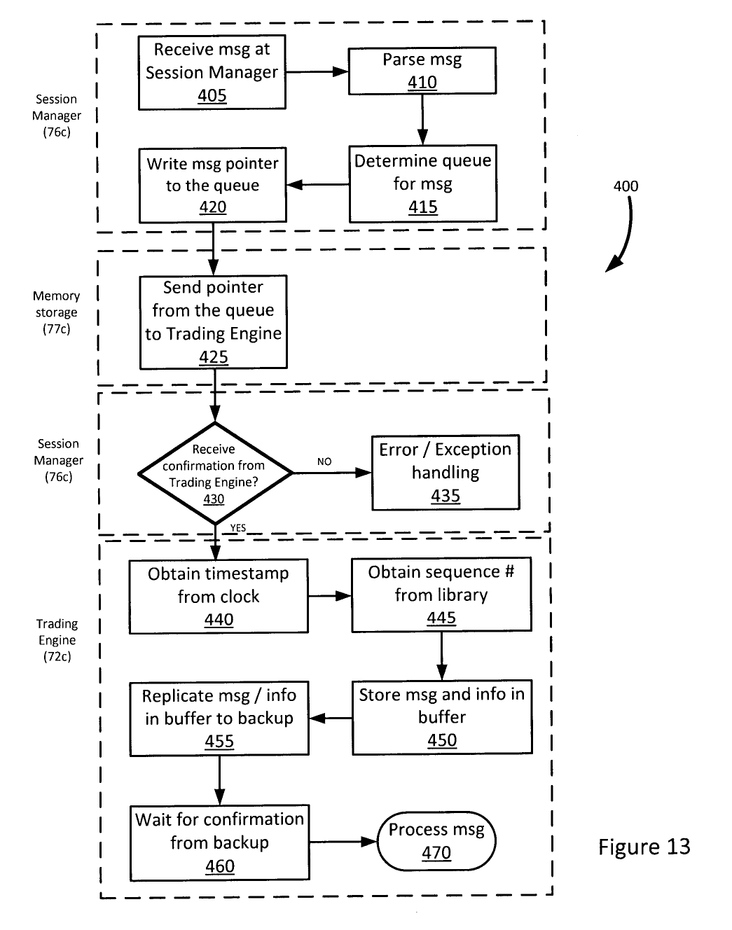

Referring now to FIG. 13, a flowchart depicting another embodiment of a method for processing orders at a primary server 62c is indicated generally at 400. In order to assist in the explanation of the method, it will be assumed that method 400 is carried out using system 50c as shown in FIG. 12. Furthermore, the following discussion of method 400 will lead to further understanding of system 50c and its various components. For convenience, various process blocks of method 400 are indicated in FIG. 13 as occurring within certain components of system 50c. Such indications are not to be construed in a limiting sense. It is to be understood, however, that system 50c and/or method 400 can be varied, and need not work as discussed herein in conjunction with each other, and the blocks in method 400 need not be performed in the order as shown. For example, various blocks can be performed in parallel rather than in sequence. Such variations are within the scope of the present invention. Such variations also apply to other methods and system diagrams discussed herein.

Block 405 comprises receiving an input message from the client machine 54c at the session manager 76c. The type of input message is not particularly limited and is generally complementary to an expected type of input message for a service executing on the primary server 62c. In the present embodiment, the input message can be a “buy order”, “sell order”, or “cancel order” for a share. In addition, the input message can also be another type of message such as a price feed message. In the present example, the input message can be assumed to be the same as input message M(O₁) described above in Table I for the purpose of describing the method 400.

Block 410 comprises parsing, at the session manager 76c, the input message M(O₁). The manner by which the message is parsed is not particularly limited. In the present embodiment, the input message M(O₁) is generally received at the session manager 76c as a single string. Accordingly, the session manager 76c can be configured to carry out a series of operations on the input message M(O₁) in order to separate and identify the fields shown in Table I.

Block 415 comprises determining, at the session manager 76c, a queue in the memory storage 77c into which the pointer to the input message M(O₁) is to be written. The manner by which the determination is made is not particularly limited. For example, in the present embodiment, the session manager 76c includes a separate queue for each security identified in field number 2 of the input message M(O₁) as shown in Table I. Accordingly, the session manager 76c can make the determination based on a list or lookup table corresponding the security name with the queue. In the present example, it is to be assumed that the input message M(O₁) corresponds with the queue 77c-1.

Next, block 420 comprises writing the pointer to the input message M(O₁) to a queue in the memory storage 77c. Continuing with the present example, the session manager 76c writes the pointer to the input message M(O₁) to the queue 77c-1.

Block 425 comprises sending the pointer to the input message M(O₁) from the queue 77c-1 of the memory storage 77c to the order processing engine 72c. For the purpose of the present example, it is to be assumed that the pointer to the input message M(O₁) is sent to the engine component 88c-1. In the present embodiment, if the engine component 88c-1 successfully receives the pointer to the input message M(O₁), the engine component 88c-1 will provide the session manager 76c with a confirmation.

Block 430 comprises determining whether a confirmation has been received from the order processing engine 72c. For example, the session manager 76c can be configured to wait a predetermined amount of time for the confirmation to be received. If no confirmation is received within the predetermined time, the method 400 proceeds to block 435. Block 435 comprises an exception handling routine. It is to be appreciated that the manner by which block 435 is carried out is not particularly limited. For example, in some embodiments, block 435 can involve repeating block 425. In other embodiments, block 435 can include ending the method 400. If a confirmation is received, the session manager 76c has completed processing the input message M(O₁) and removes the pointer to it from the queue 77c-1 to provide space for additional pointers to input messages.

After providing the confirmation to the session manager 76c, the component of the order processing engine 72c will proceed with processing the input message M(O₁). Continuing with the present example, upon receiving the pointer to the input message M(O₁), the engine component 88c-1 obtains a timestamp from the clock 300c at block 440. The manner by which the engine component 88c-1 obtains the timestamp from the clock 300c is not particularly limited. In the present embodiment, the engine component 88c-1 reads a variable local to the application process that is updated by the clock 300c. In other embodiments the engine component 88c-1 can continuously receive a feed of timestamps from which the engine component 88c-1 takes the most recently received timestamp value.

In the present example, block 445 comprises obtaining a sequence number from the library 308c-1. It is to be appreciated that in other examples of the system 50c, block 445 can involve obtaining a sequence number from the library 308c-2 or 308c-3 of the corresponding engine component 88c-2 or 88c-3, respectively, if these engine components were used instead of the engine component 88c-1. In other embodiments, it is to be understood with the benefit of this description, that a group of engine components can share one or more libraries. The manner by which the engine component 88c-1 obtains the sequence number from the library 308c-1 is not particularly limited. In the present embodiment, the engine component 88c-1 sends a call to the library 308c-1. The library 308c-1 can then respond to the call with a sequence number.

Block 450 comprises storing the input message M(O₁) and deterministic information such as the timestamp and the sequence number in the buffer 304c-1 for subsequent replication. It is to be appreciated that in other examples of the system 50c, block 450 can involve storing an input message in the buffer 304c-2 or 304c-3 of the corresponding engine component 88c-2 or 88c-3, respectively, if these engine components were used instead of the engine component 88c-1. In other embodiments, it is to be understood with the benefit of this description, that a group of engine components can share one or more buffers.

Block 455 comprises replicating the input message M(O₁) and deterministic information, such as the timestamp and the sequence number, stored in the buffer 304c-1 for subsequent replication to the backup server 64c. The manner by which the input message M(O₁) and the deterministic information are replicated is not particularly limited and can involve various manners from transferring data between servers. In the present embodiment, the input message M(O₁) and the deterministic information are replicated via the direct connection 60c.

Block 460 comprises waiting for a confirmation message from the backup server 64c that the replicated input message M(O₁) and the deterministic information has been received. In the present embodiment, during this waiting period, the order processing engine 72c is in an idle state where no further action is taken. It is to be appreciated that in some embodiments, the method 400 can be modified to include a timeout feature such that if no confirmation has been received before a predetermined length of time, the primary server 62c can identify a failure in the system 50c.

After receiving the confirmation from the backup server 64c, the method 400 proceeds to block 470 to process the input message M(O₁) and the deterministic information. Continuing with the present example, block 470 is carried out by the engine component 88c-1 to process the order for 1000 shares of ABC Co.

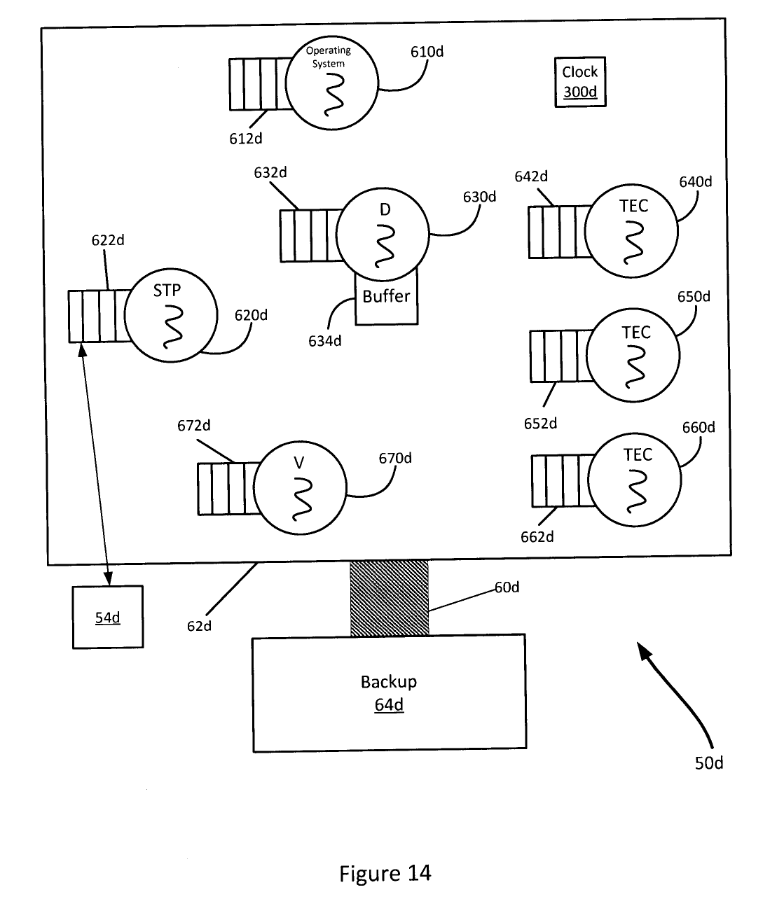

Referring to FIG. 14, a schematic block diagram of another embodiment of a system for failover is indicated generally at 50d. Like components of the system 50d bear like reference to their counterparts in the system 50, except followed by the suffix “d”. The system 50d includes a client machine 54d, a primary server 62d, and a backup server 64d. In the present embodiment, a direct connection 60d connects the primary server 62d and the backup server 64d. The direct connection 60d is not particularly limited and can include various types of connections including those discuss above in connection with other embodiments.

In the present embodiment, the primary server 62d can be any type of computing device operable to receive and process input messages from the client machine 54d, such as those discussed above in connection with other embodiments. Similar to the primary server 62, the primary server 62d of the present embodiment operates as an on-line trading system, and is thus able to process input messages that include orders related to shares that can be traded on-line. For example, the orders can include an order to purchase or sell a share, or to cancel a previously placed order. More particularly in the present embodiment, the primary server 62d is configured to execute orders received from the client machine 54d.

In the present embodiment, instead of having threads of execution carried out by various processor cores assigned by an operating system of the primary server 62d, the primary server 62d includes dedicated processor cores 620d, 630d, 640d, 650d, 660d, and 670d. Each of the dedicated processor cores 620d, 630d, 640d, 650d, 660d, and 670d are configured to continuously execute a single thread of programmed instructions. Furthermore, each of the processor cores 610d, 620d, 630d, 640d, 650d, 660d, and 670d includes a queue 612d, 622d, 632d, 642d, 652d, 652d, and 672d, respectively, for queuing pointers to messages to be processed.

The processor core 610d is generally configured to run an operating system for managing various aspects of the primary server 62d. For example, in the present embodiment, the processor core 610d is not dedicated to any single thread of execution. The manner by which the operating system of the primary server 62d manages is not particularly limited and can involve various methods such as load balancing other processes among the remaining processor cores of the primary server 62d which have not been dedicated to a specific thread of execution.

The processor core 620d is generally configured to operate as a session termination point to receive an input message from the client machine 54c via a network and to send an output message to the client machine 54c via the network. It is to be understood that the manner by which the processor core 620d receives input messages is not particularly limited and a wide variety of different applications directed to on-line trading systems can be used.

The processor core 630d is generally configured to operate as a dispatcher. In the present embodiment the processor core 630d communicates with various resources, such as a clock 300d to obtain deterministic information, such as a timestamp. In addition, the processor core 630d is further configured to assign a sequence number to be associated with the input message. Furthermore, the processor core 630d is configured to dispatch the input message and the deterministic information to another processor core 640d, 650d, or 660d for further processing.

The processor core 630d additionally includes a buffer 634d for storing an input message along with deterministic information. The processor core 630d is further configured to replicate the input message and the deterministic information to the backup server 64d. As discussed above, the deterministic information is not particularly limited and can include information from various sources such as a timestamp as well as the sequence number assigned by the processor core 630d.

In the present embodiment, the processor cores 640d, 650d, or 660d are each generally configured to operate as engine cores. It is to be appreciated that in the present embodiment, the engine cores operate as trading engine cores (TEC); however, it is to be appreciated that the engine cores can be modified to be able to process other orders. In particular, the processor cores 640d, 650d, or 660d are configured to process an input message along with deterministic information. Each of the processor cores 640d, 650d, or 660d includes a queue 642d, 652d, and 662d, respectively. The queues 642d, 652d, or 662d are each configured to receive a pointer to an input message and deterministic information from the processing core 630d for further processing. In the present embodiment each of the processor cores 640d, 650d, or 660d retrieves the pointer to the input message and deterministic information from the queue 642d, 652d, or 662d, respectively and processes the input message and deterministic information. It is to be appreciated, with the benefit of this description, that each of the processor cores 640d, 650d, or 660d is configured to receive a different type of input message. The type of input message associated with the specific processor cores 640d, 650d, or 660d is not particularly limited and can be determined using a variety of methods such as analyzing the contents of the input message. For example, the processor core 640d can be configured to process input messages relating to a first group of securities, such as securities related to a specific industry sector or securities within a predetermined range of alphabetically sorted ticker symbols, whereas the processor core 650d can be configured to process input messages relating to a second group of securities. Those skilled in the art will now appreciate that various input messages can be processed in parallel using corresponding processor cores 640d, 650d, or 660d to provide multi-threading, where several parallel threads of execution can occur simultaneously. Since the availability of each of the processor cores 640d, 650d, or 660d can vary due to a number of conditions, the process can give rise to non-deterministic results such that the first input message received at the processor core 620d may not necessarily correspond to the first output processed unless the deterministic information is considered.

It is to be re-emphasized that each of the processor cores 640d, 650d, or 660d described above is a non-limiting representation only. For example, although the present embodiment shown in FIG. 14 includes three processor cores 640d, 650d, or 660d as engine cores, it is to be understood that the primary server 62d can be modified to include more or less engine cores.

The processor core 670d is generally configured to receive an output message from the processor cores 640d, 650d, or 660d and compare it with the output message received from the backup server 64c. The output message is not particularly limited and generally includes a result of processing the input message from the processor cores 640d, 650d, or 660d. For example, when the input message is an order to purchase shares, the output message from the processor cores 640d, 650d, or 660d can indicate whether the shares have been purchased or whether the order for the purchase of shares was unable to be filled in accordance with parameters identified in the input message. Similarly, when the input message is an order to sell shares, the output message from the processor cores 640d, 650d, or 660d can indicate whether the shares have been sold or whether the order to sell the shares was unable to be filled in accordance with parameters identified in the input message It is to be appreciated that the processor core 670d carries out a verification role to ensure that the output generated at the backup server 64c is consistent with the output generated at the primary server 62d.

The clock 300d is generally configured to operate as a tick counter and is generally configured to measure time for providing a timestamp when a function call is made. The manner by which the clock 300d measures time is not particularly limited and can include a wide variety of mechanisms for measuring time. Furthermore, the manner by which a timestamp is provided is not particularly limited. In the present embodiment, the clock 300d is configured to continuously update a timestamp variable local to the application process. In other embodiments, the clock 300d can be configured to receive a call message from processor core 630d requesting a timestamp. In response, the clock 300d sends a timestamp message to the processor core 630d.

Similar to the primary server 62d, the backup server 64d can be any type of computing device operable to receive and process input messages and deterministic information from the client machine 54d. It is to be understood that the backup server 64d is not particularly limited to any machine and that several different types of computing devices are contemplated such as those contemplated for the primary server 62d. The backup server 64d is configured to assume a primary role normally assumed by the primary server 62d, during a failover event and a backup role at other times. Although the schematic block diagram of FIG. 14 shows the primary server 62d and the backup server 64d having two different sizes, it is to be understood that the schematic block diagram is intended to show the internal components of the primary server 62d. Accordingly, in the present embodiment, the backup server 64d includes similar hardware and software as the primary server 62d. However, in other embodiments, the backup server 64d can be a different type of computing device capable of carrying out similar operations.

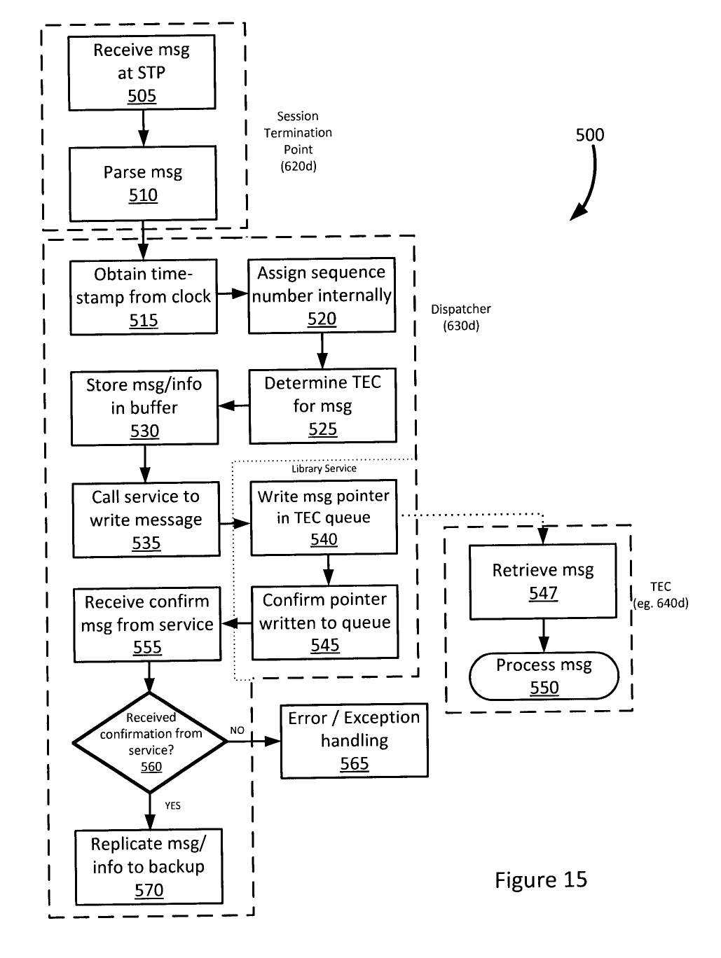

Referring now to FIG. 15, a flowchart depicting another embodiment of a method for processing orders at a primary server 62d is indicated generally at 500. In order to assist in the explanation of the method, it will be assumed that method 500 is carried out using system 50d as shown in FIG. 14. Furthermore, the following discussion of method 500 will lead to further understanding of system 50d and its various components. For convenience, various process blocks of method 500 are indicated in FIG. 15 as occurring within certain components of system 50d. Such indications are not to be construed in a limiting sense. It is to be understood, however, that system 50d and/or method 500 can be varied, and need not work as discussed herein in conjunction with each other, and the blocks in method 500 need not be performed in the order as shown. For example, various blocks can be performed in parallel rather than in sequence. Such variations are within the scope of the present invention. Such variations also apply to other methods and system diagrams discussed herein.

Block 505 comprises receiving an input message from the client machine 54d at the processor core 620d. The type of input message is not particularly limited and is generally complementary to an expected type of input message for a service executing on the primary server 62d. In the present embodiment, the input message can be a “buy order”, “sell order”, or “cancel order” for a share. In addition, the input message can also be another type of message such as a price feed message. In the present example, the input message can be assumed to be the same as input message M(O₁) described above in Table I for the purpose of describing the method 500.

Block 510 comprises parsing, at the processor core 620d, the input message M(O₁). The manner by which the message is parsed is not particularly limited. In the present embodiment, the input message M(O₁) is generally received at the processor core 620d as a single string. Accordingly, the processor core 620d can be configured to carry out a series of operations on the input message M(O₁) in order to separate and identify the fields shown in Table I. After parsing the input message M(O₁), the processor core 620d writes the pointer to the parsed input message M(O₁) into the queue 632d for the processor core 630d.

Block 515 comprises the processor core 630d obtaining a timestamp from the clock 300d. The manner by which the processor core 630d obtains the timestamp from the processor clock 300d is not particularly limited. In the present embodiment, the processor core 630d reads a timestamp variable local to the application process that is continuously update by the clock 300d. In other embodiments the processor core 630d can send a call to the clock 300d. The clock 300d can then respond to the call with a timestamp.

Block 520 comprises the processor core 630d assigning a sequence number to be associated with the input message M(O₁). The manner by which the sequence number is assigned is not particularly limited. In the present embodiment, the processor core 630d carries out a routine to provide sequence numbers based on the order which input messages arrive. In the present embodiment, the timestamp and the sequence number form at least a portion of the deterministic information associated with the input message M(O₁).

Block 525 comprises the processor core 630d determining the queue 642d, 652d, or 662d into which the pointer to the input message M(O₁) and the deterministic information obtained in blocks 515 and 520 are to be written. The manner by which the determination is made is not particularly limited. For example, in the present embodiment, the processor core 630d can use field number 2 of the input message M(O₁) as shown in Table I to determine which processor core 640d, 650d, or 660d is associated with the security. Accordingly, the processor core 630d can make the determination based on a list or lookup table corresponding the security name with the queue. Continuing with the present example, it is to be assumed that the input message M(O₁) corresponds with the processor core 640d.

Block 530 comprises storing the pointer to the input message M(O₁) and deterministic information, such as the timestamp and the sequence number in the buffer 634d for subsequent replication.

In the present example with the input message M(O₁), the processor core 630d calls a service from a library at block 535. The service is a series of instructions generally configured to write the pointer to the input message M(O₁) and the deterministic information obtained from blocks 515 and 520 into the queue 642d. At block 540 the library service writes the pointer to the input message M(O₁) and the deterministic information to the queue 642d for subsequent processing. Accordingly, in the present embodiment, the service is called by the processor core 630d and carried out by the processor core 630d. Upon a successful completion of the writing operation by the service, the service will provide a confirmation at block 545.

It is to be appreciated with the benefit of this description, that once the service has completed the writing operation of the pointer to the input message M(O₁) and the deterministic information to the queue 642d, the pointer to the input message M(O₁) and the deterministic information will subsequently be retrieved by the processing core 640d in the present example at block 547. The input message M(O₁) is then processed by the processor core 640d at block 550. Continuing with the present example, block 550 is carried out by the processor core 640d to process the order for 1000 shares of ABC Co.

Returning to the functions carried out by the processor core 630d of the present example, block 555 comprises receiving a result from the called service that the pointer to the input message M(O₁) and the deterministic information has been successfully written to the queue 642d. It is to be appreciated that in the present embodiment, the processor core 630d is used to sequentially carry out block 540 and block 545 while the input message M(O₁) and the deterministic information stored in the buffer 634d remains unchanged.

Although the present embodiment shows that the service from the library operates as a function call by the processor core 630d such that the service is carried out as a series of instructions on the processor core 630d, it is to be appreciated that other embodiments are contemplated and that variations are considered. For example, in other embodiments, the method 500 can be modified such that the library service is carried out on a different processor core (not shown) as long as increased latency can be tolerated. In such embodiments, the processor core 630d sends a pointer to the message and waits for the confirmation message between blocks 535 and 555 as a separate processor core carries out the services described above. Furthermore, a timeout feature can be included in such embodiments such that if no confirmation message has been received before a predetermined length of time, the primary server 62d can identify a failure in the system 50d.

Block 560 comprises determining whether the result from the service is a confirmation has been received from the service. If no confirmation is received, the method 500 proceeds to block 565. Block 565 comprises an exception handling routine. It is to be appreciated that the manner by which block 565 is carried out is not particularly limited. For example, in some embodiments, block 565 can involve repeating block 535. In other embodiments, block 565 can include ending the method 500. If a confirmation is received, the processor core 630d proceeds to block 570.

Block 570 comprises replicating the input message M(O₁) and deterministic information, such as the timestamp and the sequence number, stored in the buffer 634d to the backup server 64d. The manner by which the input message M(O₁) and the deterministic information are replicated is not particularly limited and can involve various manners from transferring data between servers. In the present embodiment, the input message M(O₁) and the deterministic information are replicated via the direct connection 60d. It is to be appreciated with the benefit of this description, that since the processor core 630d waits for confirmation from the queue 642d, the processing of the input message M(O₁) and the deterministic information at the processor core 640d would have generally started prior to the actual replication of input message M(O₁) and the deterministic information for increasing efficiency of the overall system 50d.

It is to be appreciated, with the benefit of this description that block 547 is carried out almost immediately after block 540 on a processor core 640d that is separate from the processor core 630d. Meanwhile, blocks 545 to 570 are carried out on the processor core 630d. The numbers of operations carried out at the processor core 640d and the processor core 630d can be specifically configured as shown such that block 550 is carried out prior to block 570. It is to be understood, with the benefit of this description, that in the present embodiment, the operations involved with block 550 generally use more time to be carried out than the operations of block 570. Accordingly, by starting block 550 before block 570, the system 50d can advantageously experience less idle time waiting for operations to be completed. For example, in tests, block 550 has been found to take about 5 ps to about 900 ps to complete. In particular, block 550 can take about 7 ps to about 100 ps to complete. More particularly, block 550 can take a median time of about 10 ps to complete. It is to be appreciated that in the present embodiment, the time needed to carry out block 550 is dependent on the complexity of an order such as how many parts the order is divided into in order to fill the order. Meanwhile, block 570 has been found to take up to 5 ps to complete. More particularly, block 570 can take about 1 ps to about 3 ps to complete. More particularly, block 570 can take a median time of about 2 ps to complete. Therefore, it is to be appreciated by a person of skill in the art having the benefit of this description, that a system with about five engine cores operating in parallel and associated with one dispatcher processor core can optimize the system 50d by minimizing the idle time on any processor core. In the present embodiment, the system 50d includes three processor cores 640d, 650d and 660d operating as engine cores. Therefore, it is to be appreciated that bottlenecks would tend to be advantageously in the engine cores of the system 50d instead of the replication process.

It is to be understood that the time to carry out each block is not particularly limited and the above is merely an example. In other embodiments, block 550 can have a median completion time greater than 10 ps such that the primary server 62d can be modified to accommodate more engine cores. In other embodiments, block 550 can have a median completion time less than 10 ps such that the primary server 62d can be modified to accommodate fewer engine cores so that the bottleneck does not occur at the dispatcher processor core.

Variations are contemplated. Although the present embodiment shown in FIG. 14 includes various designated processor cores, it is to be appreciated that not all threads of execution need to be designated to a processor core and that more or less processor cores can have designated threads of execution. As an example, the session termination point can be a threads of execution carried out on the primary server 62d at a processor core determined by the operating system based on a load balancing algorithm while the processor cores 640d, 650d, and 660d are fixed a specific processor cores.

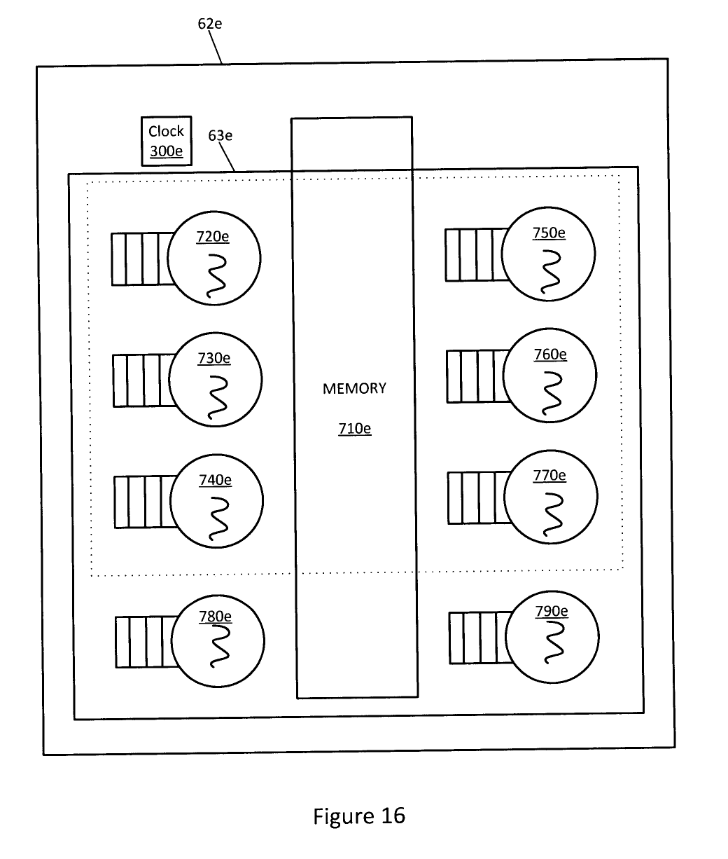

Referring to FIG. 16, a schematic block diagram of an embodiment of a server for running an application is indicated generally at 62e. It is to be appreciated that an application is generally a collection of program instructions for execution, for example, by the server 62e. It is also to be appreciated that the server 62e is not particularly limited and that the server 62e can be interchanged with any of the primary servers 62, 62a, 62b, 62c, and 62d discussed above.

In the present embodiment, the server 62e can be any type of computing device operable to receive and process input messages from the client machine such as those discussed above in connection with any of the systems 50a, 50b, 50c, or 50d. Similar to the primary server 62d, the server 62e of the present embodiment operates as part of an on-line trading system, and is thus able to process input messages that include orders related to securities that can be traded via a computer network. For example, the orders can include an order to purchase or sell shares, or an order to cancel a previously placed order. It is to be appreciated that although the server 62e operates as part of computerized trading system, the server 62e can be modified or used in other applications as a general order processing server.

For example, the server 62e can be modified to be used as part of a ticket reservation system, an online ordering system, a seat reservation system, an auction system, and as part of any other system involving message processing and competition for a limited resource.

In the present embodiment, the server 62e includes at least a processor 63e having a clock 300e, a memory storage facilities 710e, and a plurality of processor cores 720e, 730e, 740e, 750e, 760e, 770e, 780e, and 790e. The processor cores 720e, 730e, 740e, 750e, 760e, 770e, 780e, and 790e are not particularly limited and can communicate with each other using various methods. For example, the processor cores 720e, 730e, 740e, 750e, 760e, 770e, 780e, and 790e can be located on a single processor chip and be in direct electrical communication (for example, via an internal bus) such that messages and data can be transferred between each processor core. In other embodiments, the processor cores 720e, 730e, 740e, 750e, 760e, 770e, 780e, and 790e can be divided between two processors on a single circuit board or different circuit boards and communicate via an external bus or network connection. Furthermore, it is to be appreciated, that although the present example illustrates eight processor cores 720e, 730e, 740e, 750e, 760e, 770e, 780e, and 790e, more or fewer processor cores can be used. In some embodiment, the servers can include two processors, each having twelve cores for a total of 24 cores. For example, each processor can be an INTEL XEON processor such as model E5-2697v2, or alternatively, model E5-2687W. As another example, each processor can be an AMD OPTERON 6386 SE processor.

The clock 300e is generally configured to operate as a tick counter and is generally configured to measure time for providing a timestamp. The manner by which the clock 300e measures time is not particularly limited and can include a wide variety of mechanisms for measuring time. For example, the clock 300e can measure time using a programmable interval timer or by using a crystal oscillator. Furthermore, the manner by which a timestamp is provided is not particularly limited. In the present embodiment, the clock 300e maintains a tick counter in a register within the processor 63e. In this embodiment, the clock 300e generates a timestamp reflected into the application memory space by the operating system, and accessible to the application without requiring a discreet function call under the control of the operating system. In other embodiments, the register can be maintained on the processor die, and the tick counter can be reflected into application memory space. An application process or thread running on the processor 63e can obtain the tick count from the register using an operating system function call that references a library to return a tick count or pre-formatted timestamp (e.g., HH:MM:SS).

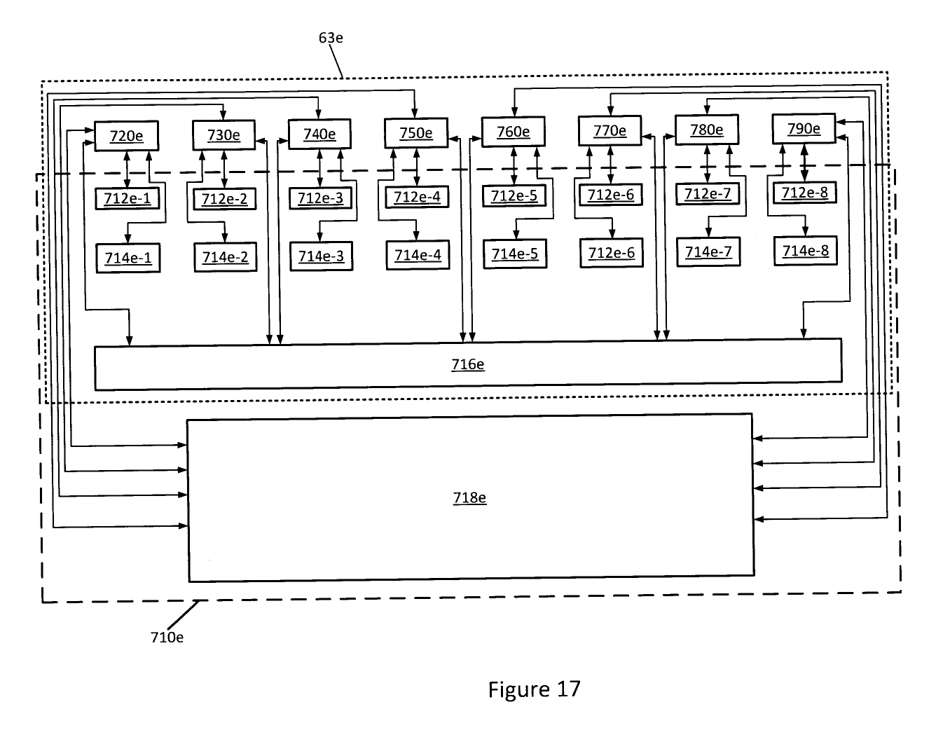

Referring to FIG. 17, a schematic block diagram of the memory storage facility 710e is shown in greater detail. The memory storage facility 710e is generally configured to store data, some or all of which can be shared between the processor cores 720e, 730e, 740e, 750e, 760e, 770e, 780e, and 790e.

In the present embodiment, the processor's memory storage facility 710e includes a plurality of Level 1 cache units 712e-1, 712e-2, 712e-3, 712e-4, 712e-5, 712e-6, 712e-7, and 712e-8. Each of the Level 1 cache units 712e-1, 712e-2, 712e-3, 712e-4, 712e-5, 712e-6, 712e-7, and 712e-8 is associated with one of the processor cores 720e, 730e, 740e, 750e, 760e, 770e, 780e, and 790e, respectively, and can be accessed by the associated processor core. Accordingly, since the data in each of the the Level 1 cache units 712e-1, 712e-2, 712e-3, 712e-4, 712e-5, 712e-6, 712e-7, and 712e-8 can be accessed by the associated processor core, the data stored in the Level 1 cache unit is generally for use during the execution of a thread of program instructions associated with a single processor core. It is to be appreciated that each of the Level 1 cache units 712e-1, 712e-2, 712e-3, 712e-4, 712e-5, 712e-6, 712e-7, and 712e-8 is generally configured to provide fast access to memory for a single processor core for data that is accessed frequently by a processor core during the execution of a thread. In the present embodiment, each of the Level 1 cache units 712e-1, 712e-2, 712e-3, 712e-4, 712e-5, 712e-6, 712e-7, and 712e-8 provides about 32 kilobytes of storage. It is to be appreciated, with the benefit of this description, that the Level 1 cache units 712e-1, 712e-2, 712e-3, 712e-4, 712e-5, 712e-6, 712e-7, and 712e-8 are not particularly limited and can be modified to be larger or smaller.

The memory storage facility 710e further includes a plurality of Level 2 cache units 714e-1, 714e-2, 714e-3, 714e-4, 714e-5, 714e-6, 714e-7, and 714e-8. Each of the Level 2 cache units 714e-1, 714e-2, 714e-3, 714e-4, 714e-5, 714e-6, 714e-7, and 714e-8 is associated with a single processor core and provides about 256 kilobytes of storage. In the present embodiment, the Level 2 cache unit 714e-1 is associated with the processor core 720e. Each of the dedicated Level 2 cache units 714e-1, 714e-2, 714e-3, 714e-4, 714e-5, 714e-6, 714e-7, and 714e-8 can be accessed by the associated processor core 720e, 730e, 740e, 750e, 760e, 770e, 780e, and 790e, respectively, in the present embodiment. It is to be appreciated that each of the Level 2 cache units 714e-1, 714e-2, 714e-3, 714e-4, 714e-5, 714e-6, 714e-7, and 714e-8 is generally configured to provide fast access to memory for its processor core for data that is accessed frequently by the processor core during the execution of threads of program instructions. In the present embodiment, each of the Level 2 cache units 714e-1, 714e-2, 714e-3, 714e-4, 714e-5, 714e-6, 714e-7, and 714e-8 is about 256 kilobytes. Since the Level 2 cache units 714e-1, 714e-2, 714e-3, 714e-4, 714e-5, 714e-6, 714e-7, and 714e-8 are larger than the Level 1 cache units 712e-1, 712e-2, 712e-3, 712e-4, 712e-5, 712e-6, 712e-7, and 712e-8, it is to be understood that although accessing the Level 2 cache units 714e-1, 714e-2, 714e-3, 714e-4, 714e-5, 714e-6, 714e-7, and 714e-8 is relatively fast, accessing the Level 2 cache units is generally slower than the accessing the Level 1 cache units. It is to be appreciated that the Level 2 cache units 714e-1, 714e-2, 714e-3, 714e-4, 714e-5, 714e-6, 714e-7, and 714e-8 are not particularly limited and can be modified to be larger or smaller in other embodiments.

The memory storage facility 710e further includes a Level 3 cache unit 716e. In embodiments including multiple processors, each processor includes its own Level 3 cache unit accessible by each of the processor cores comprising the processor. In the present embodiment, the Level 3 cache unit 716e is accessible by each of the processor cores 720e, 730e, 740e, 750e, 760e, 770e, 780e, and 790e. Accordingly, since more than a single processor core can access the data stored in the Level 3 cache unit 716e, the processor 63e can be configured to pass data from a thread running on one processor core to another thread running on another processor core using the Level 3 cache unit 716e. It is to be appreciated that the Level 3 cache unit 716e is generally configured to provide fast access to memory for the plurality of processor cores 720e, 730e, 740e, 750e, 760e, 770e, 780e, and 790e for data that is accessed frequently by different processor cores during the execution of threads of program instructions. In the present embodiment, the Level 3 cache unit 716e is about 30 megabytes. Since the Level 3 cache unit 716e is larger than the Level 2 cache units 714e-1, 714e-2, 714e-3, 714e-4, 714e-5, 714e-6, 714e-7, and 714e-8, it is to be understood that although accessing the Level 3 cache unit 716e is relatively fast, accessing the Level 3 cache unit 716e is generally slower than the accessing the Level 2 cache units 714e-1, 714e-2, 714e-3, 714e-4, 714e-5, 714e-6, 714e-7, and 714e-8. It is to be appreciated that the Level 3 cache unit 716e is not particularly limited and can be modified. For example, the Level 3 cache can be larger or smaller than 30 megabytes in other embodiments.

The memory storage facility 710e further includes a random access memory unit 718e. The random access memory unit 718e is not particularly limited and can include a wide variety of different memory modules. For example, the random access memory unit 718e can be a single in-line memory module (SIMM), or dual in-line memory module (DIMM). In the present embodiment, the random access memory unit 718e is located outside of the processor 63e. The random access memory unit 718e is accessible by each of the processor cores 720e, 730e, 740e, 750e, 760e, 770e, 780e, and 790e. Accordingly, since more than a single processor core can access the data stored in the random access memory unit 718e, the processor 63e can be configured to pass data from a thread running on one processor core to another thread running on another processor core using the random access memory unit 718e in addition to the Level 3 cache unit 716e or data that is accessed less frequently to free space in the Level 3 cache unit 716e. It is to be appreciated that the random access memory unit 718e is generally configured to provide access to memory for the processor cores 720e, 730e, 740e, 750e, 760e, 770e, 780e, and 790e for storing data generally too large to be stored in the Level 3 cache unit 716e. In the present embodiment, the random access memory unit 718e is about 128 gigabytes.

As a whole, the memory storage facility 710e is generally configured to be used to store data from a thread of program instructions running on one of the processor cores 720e, 730e, 740e, 750e, 760e, 770e, 780e, and 790e as well as share data between various threads. The manner by which the data is stored in the memory storage facility 710e is not particularly limited. In the present embodiment, the determination of whether data is stored in the Level 1 cache units 712e-1, 712e-2, 712e-3, 712e-4, 712e-5, 712e-6, 712e-7, and 712e-8; the Level 2 cache units 714e-1, 714e-2, 714e-3, and 714e-4; the Level 3 cache unit 716e or the random access memory unit 718e is carried out by a processor 63e. For example, for a relatively small amount of data that is accessed frequently by a single processor core, such as a pointer variable pointing to a message buffer being processed by the specific thread, the processor 63e can store that variable in one of the Level 1 cache units 712e-1, 712e-2, 712e-3, 712e-4, 712e-5, 712e-6, 712e-7, and 712e-8, or the Level 2 cache units 714e-1, 714e-2, 714e-3, and 714e-4. As another example, for a relatively small amount of data that needs to be shared between another thread running on one other processor core, such as a pointer variable pointing to an input message, the processor 63e can store this pointer variable in the Level 3 cache unit 716e for sharing the data between processor cores. It is to be appreciated with the benefit of this description that when designing the application, it is advantageous for threads that share a large amount of data with one other processor core to be dedicated to cores which share a Level 3 cache unit. As another example, for a relatively small amount of data that needs to be shared between several threads running on several processor cores, such as a pointer variable pointing to an input message which is partially processed by a plurality of threads in a deterministic manner, the processor 63e can store the pointer variable in the Level 3 cache unit 716e. As yet another example, for larger amounts of data that cannot be effectively stored in any one of the cache units or for data that is not frequently accessed, the processor 63e can store this data in the random access memory unit 718e.

In embodiments including multiple processors within a single server, the memory storage facility 710e, specifically, the main memory 718e, can be generally configured to be used to share data between the processor cores residing within separate processors comprising the server.

In the present embodiment, the operating system controlling the processor 63e can dynamically move data between the various portions of the memory storage facility 710e to reduce the amount of latency introduced from accessing memory. It is to be appreciated that the speed at which the processor cores 720e, 730e, 740e, 750e, 760e, 770e, 780e, and 790e can access the various portions of the memory storage facility 710e is effectively instantaneous (nanoseconds) relative to the time scales involved with executing threads (microseconds). Accordingly, the latency introduced by accessing different portions of memory can be optimized to improve the speed of the server 62e by taking advantage of the cumulative effects of using faster portions of the memory storage facility 710e, but generally does not introduce significant non-determinism into the application. As an example in accordance with the present embodiment, each of the dedicated processor cores 720e, 730e, 740e, 750e, 760e, and 770e are configured to run a specific deterministic thread of program instructions of the application that has been pre-defined such to optimize the usage of the memory storage facility 710e while the processor cores 780e and 790e are available for other applications or processes. For example, two deterministic threads of program instructions sharing a large amount of data can be configured to be dedicated to the processor cores 720e and 730e using a pre-selection process. Accordingly, the processor cores 720e and 730e can then share data using pointer variables stored in the Level 3 cache unit 716e to optimize use of the memory storage facility 710e to reduce latency.

In general terms, the memory storage facility 710e further comprises volatile memory and is generally configured to provide temporary data storage for fast access by each of the processor cores 720e, 730e, 740e, 750e, 760e, 770e, 780e, and 790e. It is to be re-emphasized that the structure shown in FIG. 17 is a non-limiting representation only. Notwithstanding the specific example, it is to be understood that other configurations of various types of volatile memory can be devised to perform a similar function as the memory storage facility 710e. For example, the memory storage facility 710e can be modified to be a single uniform piece of memory located either completely within the processor 63e or completely outside of the processor 62e.

It is to be appreciated with the benefit of this description that volatile memory is used to increase the speed of the reading and writing operations. In the event that data is to be stored persistently, the server 62e sends data to be stored persistently to another device (not shown) over a fast network link, such as a PCIe link as discussed above. The other device can then store the data to a persistent storage device such as a hard drive or other storage medium. It is to be appreciated that the data for persistent storage can also be collected for batch writing to a non-volatile memory storage facility for more efficient use of resources.

In the present embodiment, each of the processor cores 720e, 730e, 740e, 750e, 760e, 770e, 780e, and 790e is generally configured to run a single thread of program instructions at a time. A thread of program instructions is a series of pre-defined instructions configured to be executed sequentially. The thread of program instructions is typically implemented and managed by an operating system, such as Unix or Linux. In general, the operating system is configured to manage the shared hardware resources of the server, including the processor cores, as well as provide common services for computer programs. Accordingly, the operating system traditionally schedules and assigns each thread of instructions to whichever core is available at the time or based on some other optimization logic. By running applications through the use of an operating system, additional operations associated with scheduling threads of program instructions and managing system resources typically need to be carried out. Since the delay introduced by the additional operations is generally unpredictable due to other functions of the operating system unrelated to the application, multiple threads of program instructions scheduled by the operating system for execution on multiple processor cores would be non-deterministic unless the operating system waits for confirmation from each thread of program instructions before beginning a second thread of program instructions in the sequence. It is to be appreciated that waiting for confirmation introduces further delays and reduces the performance of the server 62e. In addition to scheduling threads of program instructions to a processor core, the operating system also traditionally allocates and manages portions of the memory storage facility 710e to which each processor core 720e, 730e, 740e, 750e, 760e, 770e, 780e, and 790e can write. For example, the operating system can keep records or allocation tables of which portions of the memory storage facility 710e are allocated or available for use. The operating system can also limit access to portions of the memory storage facility 710e to a specific application process.

Each of the processor cores 720e, 730e, 740e, 750e, 760e, 770e, 780e, and 790e are identical to each other. It is to be appreciated that the processor cores 720e, 730e, 740e, 750e, 760e, 770e, 780e, and 790e are not particularly limited and can be different in other embodiments. In the present embodiment, upon booting up the server 62e, each of the processor cores 720e, 730e, 740e, 750e, 760e, 770e, 780e, and 790e are managed and controlled by the operating system. Once the application is started on the server 62e, the operating system can dedicate two or more processor cores to the application. In the present embodiment shown in FIG. 16, the operating system is shown to have dedicated the processor cores 720e, 730e, 740e, 750e, 760e, and 770e to the application.

Each of the dedicated processor cores 720e, 730e, 740e, 750e, 760e, and 770e are configured to run a specific deterministic thread of program instructions of the application. For example, the dedicated processor cores 720e, 730e, 740e, 750e, 760e, and 770e can poll a queue associated with the dedicated processor cores 720e, 730e, 740e, 750e, 760e, and 770e for data to be processed. In the present embodiment, each of the dedicated processor cores 720e, 730e, 740e, 750e, 760e, and 770e is continuously running and polling for data to process such that once data is placed in the associated queue, the data is processed by the thread of program instructions almost immediately. Once each of the dedicated processor cores 720e, 730e, 740e, 750e, 760e, and 770e begins to execute the specific deterministic thread of program instructions, the dedicated processor cores 720e, 730e, 740e, 750e, 760e, and 770e continuously run their threads of program instructions independently of the operating system. Accordingly, the threads of program instructions running on the dedicated processor cores 720e, 730e, 740e, 750e, 760e, and 770e operate in isolation from the operating system to process data in their associated queue and/or to poll for further data. In particular, the threads of program instructions running on the dedicated processor cores 720e, 730e, 740e, 750e, 760e, and 770e operate in isolation from the operating system such that they cannot be preempted to process an interrupt from the system, or to have other threads of execution assigned to them by the operating system. Therefore, the dedicated processor cores 720e, 730e, 740e, 750e, 760e, and 770e are each effectively pinned to a specific thread of program instructions and are not preempted by the operating system or system interrupts once the specific deterministic thread of program instructions has begun. Although six processor cores are illustrated to be dedicated to the application in FIG. 16, the operating system of the server 62e can dedicate more or less than six cores to the application in other embodiments.

Although each of the dedicated processor cores 720e, 730e, 740e, 750e, 760e, and 770e is configured to run the specific deterministic thread of program instructions indefinitely, the operating system can terminate the thread of program instructions. For example, the operating system can simply remove threads of execution associated with the application from a run queue and to release the dedicated processor cores 720e, 730e, 740e, 750e, 760e, and 770e so that they receive new scheduled tasks from the operating system. In the present embodiment, each of the dedicated processor cores 720e, 730e, 740e, 750e, 760e, and 770e are identical and able to run any thread of program instructions. However, it is to be re-emphasized that the dedicated processor cores 720e, 730e, 740e, 750e, 760e, and 770e can be modified such that the hardware of each individual processor core is optimized for a specific thread.

As discussed above, the dedicated processor cores 720e, 730e, 740e, 750e, 760e, and 770e are identical to each other in the present embodiment. In other embodiments, the dedicated processor cores 720e, 730e, 740e, 750e, 760e, and 770e can be modified such that they are each specifically configured to run a specific pre-determined thread of program instructions such that the dedicated processor cores 720e, 730e, 740e, 750e, 760e, and 770e are always dedicated to a unique thread of program instructions. For example, the dedicated processor core 730e can be configured to carry out a dispatcher thread of program instructions and include a sufficiently large buffer for storing replicated messages in an internal CPU cache, where other threads can use a smaller amount of cache.

It is to be appreciated that the processor cores not dedicated to the application remain under the management and control of the operating system. In the present embodiment shown in FIG. 16, the processor cores 780e and 790e are available for the operating system to schedule threads of program instructions that are not particularly sensitive to preemption. It is to be appreciated that the threads of program instructions are not particularly limited and can include threads of program instructions associated with operating system tasks as well as other applications that can be running on the server 62e. For example, the server 62e can also be configured to run applications in addition to the order processing application that are not sensitive to preemption on the processor cores 780e and 790e such as for generating reports or maintaining a graphical user interface.

In the present embodiment, the operating system is also configured to isolate a portion of the memory storage facility 710e for exclusive use by the dedicated processor cores 720e, 730e, 740e, 750e, 760e, and 770e. The portion of the memory storage facility 710e dedicated to the dedicated processor cores 720e, 730e, 740e, 750e, 760e, and 770e is generally configured for storing data associated with the application. Each of the dedicated processor cores 720e, 730e, 740e, 750e, 760e, and 770e can share data via the memory storage facility 710e. For example, the memory storage facility 710e can be configured to store input messages and results of carrying out a thread of program instructions on an input message. In the present embodiment, data is written directly to the memory storage facility 710e by one or more of the threads of program instructions running on the dedicated processor cores 720e, 730e, 740e, 750e, 760e, and 770e.

As discussed above, each of the threads of program instructions running on the dedicated processor cores 720e, 730e, 740e, 750e, 760e, and 770e is continuously running and polling for data to process. To process a specific item of data, a pointer is placed in the queue of the processor core which points to the data stored in the memory storage facility 710e. Once the pointer is read by the thread of program instructions running on the dedicated processor core 720e, 730e, 740e, 750e, 760e, or 770e, the processor core directly reads the memory storage facility 710e and executes the program instructions specific to that item of data. It is to be appreciated with the benefit of this description, that placing pointers in the queues of the threads of program instructions running on the dedicated processor cores 720e, 730e, 740e, 750e, 760e, and 770e provides a manner by which threads of program instructions being carried out on the dedicated processor cores 720e, 730e, 740e, 750e, 760e, and 770e can communicate with one another without having to copy data from one portion of the memory storage facility 710e to another portion of the memory storage facility 710e. It is to be appreciated that by reading and writing relatively small pointer data, latency involved with reading and writing the complete data is reduced and in some cases avoided entirely. In other embodiments where this reduction is negligible, it is to be appreciated that the complete data can be copied instead.

After performing the thread of program instructions, the processor core subsequently writes the result to the memory storage facility 710e along with a pointer to the result for another thread of program instructions running on the processor core, which in turn reads the result from the memory storage facility 710e for further processing. It is to be appreciated that in other embodiments, modifications and variations are contemplated. For example, the data can be placed in a queue of a thread of program instructions running on the processor core instead of just a pointer to the data in some embodiments where the queue is sufficiently large to store this information.

It is to be appreciated that the application is generally configured to run in isolation from the operating system on the server 62e. Therefore, operations generally associated with scheduling and managing tasks among the processor cores are not required resulting in an increased speed and determinism by which the application can be executed. This increased speed and determinism is associated with reduced latency of execution and greater consistency of the latency of execution that is highly desirable for some categories of applications. Accordingly, it is to be appreciated that the configuration effectively isolates the operating system from having any role related to processes and/or threads of the application beyond application start-up and shut-down. In particular, the application includes services and libraries required to directly interact with the hardware of the server such as a network interface device and other components without having to request any services from the operating system. For example, the application can include a function for reading an application-local reflection of the clock 300e to retrieve information for providing a timestamp such that the application does not need to make any calls to operating system functions or use an operating system service. In some embodiments, it is to be appreciated that the operating system can be further avoided or bypassed using kernel bypass technology to allow the application to communicate directly with hardware such as the network interface card for sending and receiving data across the network.

It is to be appreciated that by continuously running the threads of program instructions on each of the dedicated processor cores 720e, 730e, 740e, 750e, 760e, and 770e without allowing the dedicated processor cores 720e, 730e, 740e, 750e, 760e, and 770e to run other tasks, operations associated with context switching are not required and the thread of program instructions can be executed immediately once data is placed in the queue of the threads of program instructions running on the dedicated processor cores 720e, 730e, 740e, 750e, 760e, and 770e. Furthermore, it is to be appreciated by a person of skill in the art with the benefit of this description that the server 62e is generally configured to perform a series of repetitive operations similar to the functionality that can be achieved by programming a field-programmable gate array such that operations are carried out quickly without additional steps associated with the operating system. Furthermore, it is to be appreciated that the use of processor 63e with a faster clock speed than commercially available field-programmable gate arrays can provide a faster overall processing result.

It is to be appreciated that the server 62e can be used to substitute any of the previously discussed servers such that each of the processes and/or threads of execution described above can be dedicated on to a processor core and run in isolation from the operating system.

It is to be appreciated, with the benefit of this description, that limiting access to portions of the memory storage facility 710e for each application process generally provides a more stable operating environment for the applications running on the server 62e by reducing the probability of an application process inadvertently disrupting or otherwise interfering with the portions of the memory storage facility 710e allocated to another application or another thread of execution. Disrupting a portion of the memory storage facility 710e during use by an application process typically results in rapid destabilization of the thread of execution of the application process and can lead to a fatal error resulting in termination of the application process or a general operating system crash. Therefore, variations can include embodiments where the operating system divides portions of the memory storage facility among the processor cores 720e, 730e, 740e, 750e, 760e, 770e, 780e, and 790e each running different threads of execution managed by the operating system.

Accordingly, since access to various portions of the memory storage facility 710e are limited to threads of execution running on specific processor cores 720e, 730e, 740e, 750e, 760e, 770e, 780e, and 790e, an application process running on one of the processor cores 720e, 730e, 740e, 750e, 760e, 770e, 780e, and 790e that needs to exchange data, such as a pointer to a message, with another application process running on one of the other processor cores would need to do so in a controlled manner to preserve determinism and system stability. Because the operating system restricts access to portions of the memory storage facility 710e for each application process, the operating system typically provides various mechanisms, such as various facilities, for controlled data exchange between process threads. One example is a facility that allows one application process to send a message to another application process via an operating system function call. In this example, the function call receives a message from a first application process and stores the message temporarily in a portion of the memory storage facility 710e set aside for the operating system. Subsequently, the message is sent to another portion of the memory storage facility 710e for the second application process associated with the second processor core to use.

Another example of an operating system facility to share messages is one that allows the separate process threads running on processor cores 720e, 730e, 740e, 750e, 760e, 770e, 780e, and 790e to explicitly share a portion of the memory storage facility 710e such as the Level 3 cache unit 716e or the random access memory unit 718e. In this example, an application process writes a message to an agreed-upon shared memory location, and a second application process then reads the message from the shared memory location. It is to be appreciated, with the benefit of this description, that the shared memory location can be a portion of the memory storage facility 710e accessible by the processor cores running the application processes for sharing the data. For example, if a first application process running on processor core 720e is to send a message to a second application process running on processor core 730e, the operating system can set aside a portion of the memory storage facility 710e to be accessible by both the application process running on processor core 720e and the application process running on processor core 730e. As shown in FIG. 17, the shared memory location can be on the Level 3 cache unit 716e or the random access memory unit 718e.

It is to be appreciated that using operating system facilities for data exchange between separate process threads introduces non-determinism and significant latency as a result of intermediate operations associated with the operating system. Although operating system facilities for data exchange via a shared memory location on the random access memory unit 718e reduces a large degree of the introduction of non-determinism of an operating system function call and its various memory copy operations and scheduling interruptions, it still involves additional latency associated with random access memory transfer operations to and from the server's main memory facility.

It is to be appreciated, with the benefit of this description, that facilities for data exchange using a shared portion of the Level 3 cache unit 716e for exchanging data between application process threads running on the processor cores 720e, 730e, 740e, 750e, 760e, 770e, 780e, and 790e further reduces latency. It is to be appreciated that in some embodiments, the restricted access to the portion of the memory storage facility 710e allocated to an application process imposed by the operating system does not affect the threads of program instruction running within a single application process. The threads of execution running within a single process have access to the memory within the portion of the memory storage facilities allocated to that application process. Accordingly, the operating system can be configured to assign portions of the memory storage facility such that data exchange between threads within a single application process running on separate dedicated processor cores within a single processor can be performed via the Level 3 cache unit 716e instead of the random access memory unit 718e to offer faster exchange of messages between two application process threads.

In an example, the process threads are threads of execution dedicated to separate processor cores 720e, 730e, 740e, 750e, 760e, and 770e are comprised within a single application process and data exchange between the threads of execution occur within a portion of the memory storage facility 710e allocated by the operating system to the single application process. For example, the single application process runs on the processor 63e within the server 62e, allowing data exchange between threads of program instruction execution running on the dedicated processor cores 720e, 730e, 740e, 750e, 760e, and 770e to occur via the Level 3 cache unit 716e.

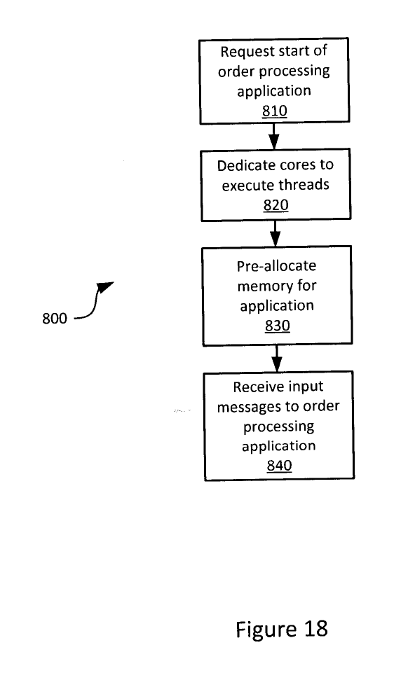

Referring now to FIG. 18, a flowchart depicting another embodiment of a method for processing orders at the server 62e is indicated generally at 800. In order to assist in the explanation of the method, it will be assumed that method 800 is carried out using server 62e as shown in FIG. 16. Furthermore, the following discussion of method 800 will lead to further understanding of the server 62e and its various components. It is to be understood, however, that server 62e and/or the method 800 can be varied, and need not work as discussed herein in conjunction with each other. For example, the method 800 can be applied to the server 62 prior to the method 100. In addition, the blocks in method 800 need not be performed in the order as shown. For example, blocks can be performed in parallel rather than in sequence. Such variations are within the scope of the present invention.

Block 810 is the start of the method 800 and includes a request to start the application. It is to be appreciated that the operating system starts the application by initially scheduling threads of program instructions as well as setting aside a portion of the memory storage facility 710e for the application. For example, block 810 can include receiving input from an external device requesting the initiation of the application. The manner by which the request is made is not particularly limited. For example, the application can be initiated manually or as a result of another application running on a separate device. Alternatively, the block 810 can be automatically executed when the server 62e is powered on during the boot-up process.

Block 820 comprises dedicating processor cores to execute specific threads of program instructions. The manner by which this dedication is carried out is not particularly limited and variations are contemplated. For example, in the present embodiment, the operating system initiates a thread of programming to be executed on a processor core that will loop indefinitely. Accordingly, since the thread of program instructions effectively does not complete, the processor core will be unavailable for any other tasks and thus dedicated to running the thread of program instructions.

Block 830 comprises pre-allocating memory for use by the application. The portion of the memory storage facility 710e set aside for the application is further pre-allocated at the start of the application such that pre-defined memory structures are created. It is to be appreciated with the benefit of this description, that by pre-allocating pre-defined memory structures, each of the threads of program instructions running on the dedicated processor cores 720e, 730e, 740e, 750e, 760e, and 770e can read and write directly from and into an existing memory structure without having to create the structure when needed.

In the present embodiment, the operating system reserves a portion of the memory storage facility 710e shared by the processor cores 720e, 730e, 740e, 750e, 760e, 770e, 780e, and 790e for the exclusive use of the threads of program instructions running on the processor cores 720e, 730e, 740e, 750e, 760e, and 770e.

Block 840 comprises receiving input messages at the application. Once the application has initiated the required threads of program instructions on the processor cores, input messages received by the server 62e can be processed by the application. Each thread of program instructions takes data from the memory storage facility 710e to generate a result, which in turn can be used by another thread of program instructions to generate another result. Therefore, the application can completely process an input message from a client and output a result without any involvement of the operating system.

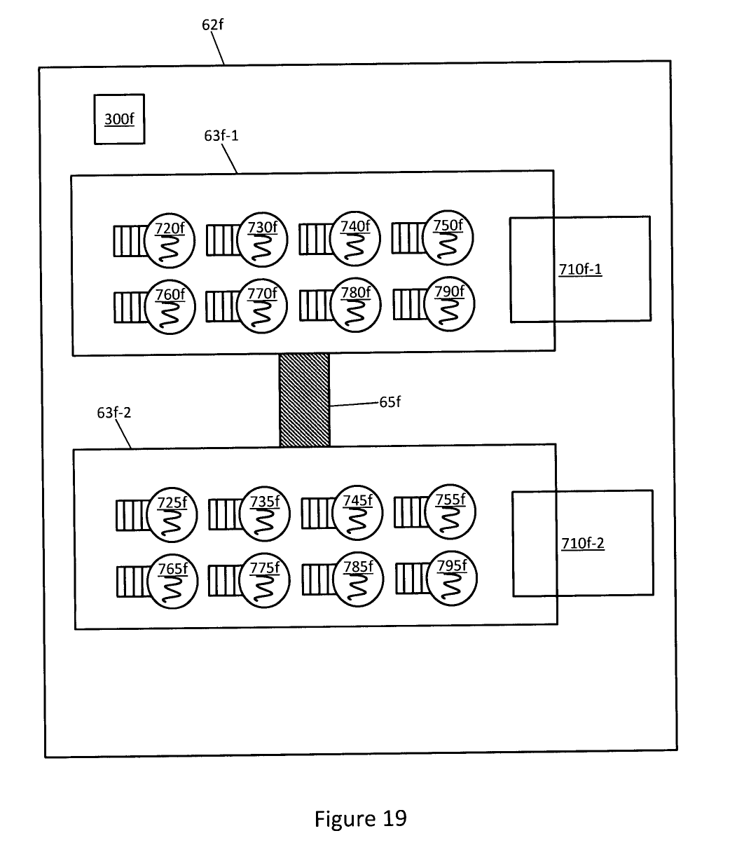

Referring now to FIG. 19, a schematic block diagram of another embodiment of a server for running an application is indicated generally at 62f. Like components of the server 62f bear like reference to their counterparts in the server 62e, except followed by the suffix “f” instead of “e”. The server 62f includes, processors 63f-1 and 63f-2, each including a clock 300f, memory storage facilities 710f-1 and 710f-2, and an inter-processor bus 65f. The processor 63f-1 includes a plurality of processor cores 720f, 730f, 740f, 750f, 760f, 770f, 780f, and 790f. The processor 63f-2 includes a plurality of processor cores 725f, 735f, 745f, 755f, 765f, 775f, 785f, and 795f. In addition, it is to be appreciated that the server 62f can be used for any of the servers 62, 62a, 62b, 62c, 62d, and 62e discussed above.

In the present embodiment, the server 62f includes a first processor 63f-1 and a second processor 63f-2 in communication via an inter-processor bus 65f. The manner by which the first processor 63f-1 and the second processor 63f-2 are connected is not particularly limited. For example, in the present embodiment one of the processor cores 720f, 730f, 740f, 750f, 760f, 770f, 780f, and 790f can utilize digital logic to use the inter-processor bus 65f to send a data item to one of the processor cores 725f, 735f, 745f, 755f, 765f, 775f, 785f, and 795f. In the present embodiment, the processor cores 720f, 730f, 740f, 750f, 760f, 770f, 780f, and 790f cannot access the data on the memory storage facility 710f-2 and communicates with one of the processor cores 725f, 735f, 745f, 755f, 765f, 775f, 785f, and 795f to access the memory storage facility 710f-2. In other embodiments, the inter-processor bus 65f can be modified to allow the processor cores 720f, 730f, 740f, 750f, 760f, 770f, 780f, and 790f to directly access the memory storage facility 710f-2.

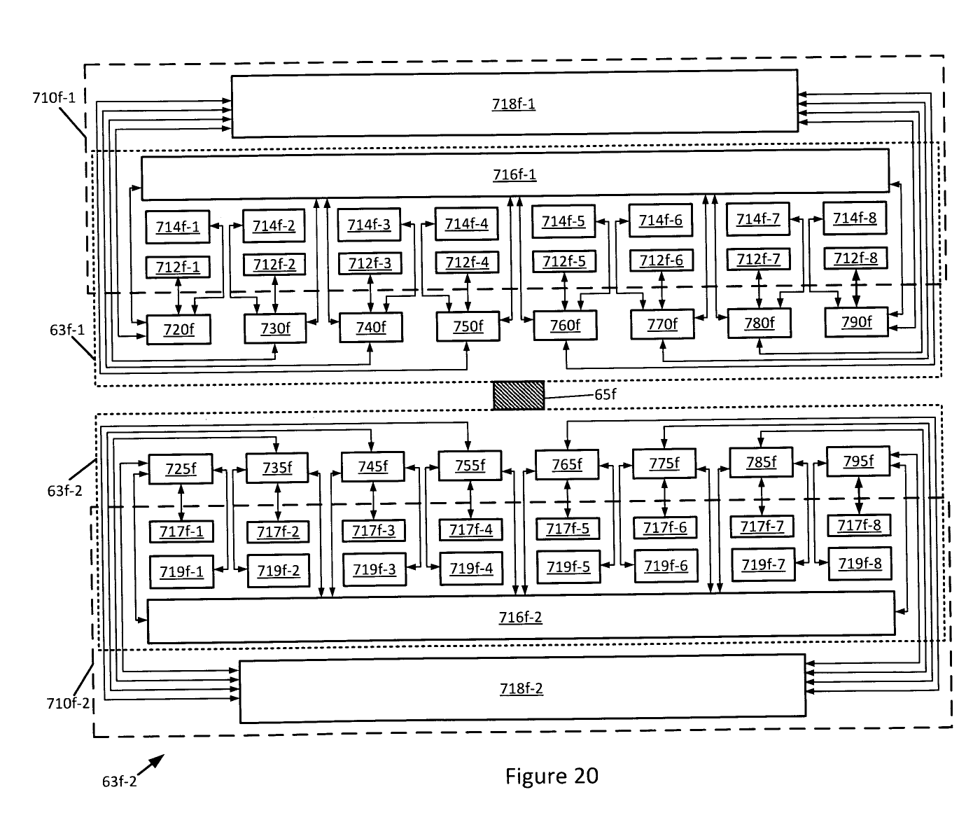

Referring to FIG. 20, a schematic block diagram of the memory storage facilities 710f-1 and 710f-2 are shown in greater detail. Like components of the server 62f bear like reference to their counterparts in the server 62e, except followed by the suffix 1″ instead of “e”. It is to be appreciated that the memory storage facilities 710f-1 and 710f-2 function similarly to the memory storage facility 710e described above.

In the present embodiment, the server 62f includes two processors 63f-1 and 63f-2. Accordingly, the server 62f can run a single application process across both of the processors 63f-1 and 63f-2. For example, the application process may require more processor cores than are available on a single processor such as the processors 63f-1 and 63f-2. However, it is to be appreciated that in some instances, it is more efficient to use processor cores on both of the processor 63f-1 and 63f-2. In the present example, data exchange between threads of program instruction execution on dedicated processor cores within a single processor (such as any of the processor cores 720f, 730f, 740f, 750f, 760f, 770f, 780f, or 790f on the processor 63f-1 or the processor cores 725f, 735f, 745f, 755f, 765f, 775f, 785f, or 795f on the processor 63f-2) can occur via the Level 3 cache units 716f-1 or 716f-2. However, it is to be appreciated, with the benefit of this specification, that data exchange between threads of program instruction execution running on dedicated processor cores on different processors (such as between a thread dedicated to the processor core 720f and a thread dedicated to the processor core 725f) can occur via the inter-processor bus 65f within the server 62f.

It is to be appreciated, with the benefit of this description, that in order to achieve the lowest possible latency, the dedication of threads of program instruction execution to the processor cores 720f, 730f, 740f, 750f, 760f, 770f, 780f, 790f, 725f, 735f, 745f, 755f, 765f, 775f, 785f, and 795f can be configured to minimize the frequency of data exchange between processor cores on different processors 63f-1 and 63f-2 in order to minimize the relatively larger latency incurred by a transfer requiring the use of the inter-processor bus 65f, and to favor the use of the Level 3 cache units 716f-1 and 716f-2 for data transfers between processor cores on the same processor whenever possible.

It is to be appreciated that the server 62f can be used to substitute any of the previously discussed servers such that each of the process threads described above can be dedicated on to a processor core and run in isolation from the operating system. In particular, the server 62f can provide additional cores to the application without increasing the number of cores in each processor.

While only specific combinations of the various features and components of the present invention have been discussed herein, it will be apparent to those of skill in the art that desired subsets of the disclosed features and components and/or alternative combinations of these features and components can be utilized, as desired. Accordingly, while specific embodiments have been described and illustrated, the scope of the claims should not be limited by the preferred embodiments set forth above, but should be given the broadest interpretation consistent with the description as a whole.

1. A server for running an application process having a first process thread and a second process thread, the server comprising:
at least one non-dedicated processor core configured to run an operating system, the at least one non-dedicated processor core configured to schedule non-deterministic threads and to initiate the application process;
a memory storage facility for storing data during execution of the application process;
a first dedicated core in communication with the memory storage facility, the first dedicated core configured to run the first process thread in isolation from the operating system, the first process thread configured to exclude making calls using the operating system; and
a second dedicated core in communication with the memory storage facility, the second dedicated core configured to run the second process thread in isolation from the operating system, the second process thread configured to exclude making calls using the operating system.

2. The server of claim 1, wherein the first dedicated core and the second dedicated core are configured to share data via the memory storage facility using a pointer variable maintained within the application process.

3. The server of claim 2, wherein the first process thread and the second process thread are configured to share data by storing the pointer variable in a cache memory unit.

4. The server of claim 1, wherein the first dedicated core is configured to run the first process thread in a loop continuously.

5. The server of claim 1, wherein the second dedicated core is configured to run the second process thread in a loop continuously.

6. The server of claim 1, wherein the first process thread and the second process thread are configured to generate deterministic results.

7. The server of claim 1, wherein the first dedicated core and the second dedicated core are pre-selected to optimize use of the memory storage facility.

8. The server of claim 1, wherein the first process thread running on the first dedicated core is configured to access a first queue, the first queue for storing a first pointer to the data to be processed by the first dedicated core.

9. The server of claim 8, wherein the first process thread running on the first dedicated core is further configured to continuously poll the first queue for additional data to be processed.

10. The server of claim 1, wherein the second process thread running on the second dedicated core is configured to access a second queue, the second queue for storing a second pointer to the data to be processed by the second dedicated core.

11. The server of claim 10, wherein the second process thread running on the second dedicated core is further configured to continuously poll the second queue for additional data to be processed.

12. The server of claim 1, wherein the memory storage facility includes a portion dedicated to the application process.

13. The server of claim 1, wherein the first dedicated core operates within a first processor and the second dedicated core operates within a second processor, the first processor and the second processor connected by an inter-processor bus.

14. A method for processing transactions, the method comprising:
scheduling non-deterministic threads using an operating system running on at least one non-dedicated processor core;
initiating, via the operating system, an application process having a first process thread and a second process thread;
storing data in a memory storage facility during execution of the application process;
running a first process thread in isolation from the operating system on a first dedicated core in communication with the memory storage facility by excluding making calls using the operating system; and
running a second process thread in isolation from the operating system on a second dedicated core in communication with the memory storage facility by excluding making calls using the operating system.

15. The method of claim 14, further comprising sharing data between the first process thread and the second process thread via the memory storage facility using a pointer variable.

16. The method of claim 15, wherein sharing comprises storing the pointer variable in a cache memory unit.

17. The method of claim 14, wherein running the first process thread comprises running the first process thread continuously in a loop.

18. The method of claim 14, wherein running the second process thread comprises running the second process thread continuously in a loop.

19. The method of claim 14, further comprising generating deterministic results using the first process thread and the second process thread.

20. The method of claim 14, further comprising pre-selecting the first dedicated core and the dedicated core to optimize use of the memory storage facility.

21. The method of claim 14, further comprising storing a first pointer in a first queue accessible by the first process thread running on the first dedicated core, the first pointer associated with data to be processed by the first process thread running on the first dedicated core.

22. The method of claim 21, further comprising continuously polling the first queue for additional data to be processed by the first process thread running on the first dedicated core.

23. The method of claim 14, further comprising storing a second pointer in a second queue accessible by the second process thread running on the second dedicated core, the second pointer associated with data to be processed by the second process thread running on the second dedicated core.

24. The method of claim 23, further comprising continuously polling the second queue for additional data to be processed by the second process thread running on the second dedicated core.

25. The method of claim 14, wherein the memory storage facility includes a portion dedicated to the application process.

26. The method of claim 14, wherein the first dedicated core operates within a first processor and the second dedicated core operates within a second processor, the first processor and the second processor connected by an inter-processor bus.

27. A non-transitory computer readable medium encoded with codes, the codes for directing a processor to:
schedule non-deterministic threads using an operating system running on at least one non-dedicated processor core;
initiate, via the operating system, an application process having a first process thread and a second process thread;
store data in a memory storage facility during execution of the application process;
run a first process thread in isolation from the operating system on a first dedicated core in communication with the memory storage facility by excluding making calls using the operating system; and
run a second process thread in isolation from the operating system on a second dedicated core in communication with the memory storage facility by excluding making calls using the operating system.

28-38. (canceled)

39. A non-transitory computer readable medium encoded with codes, the codes for directing a first processor and a second processor, the first processor and the second processor connected by an inter-processor bus, to:
schedule non-deterministic threads using an operating system running on at least one non-dedicated processor core;
initiate, via the operating system, an application process having a first process thread and a second process thread;
store data in a memory storage facility during execution of the application process;
run a first process thread in isolation from the operating system on a first dedicated core in communication with the memory storage facility by excluding making calls using the operating system, the first dedicated core operating within the first processor; and
run a second process thread in isolation from the operating system on a second dedicated core in communication with the memory storage facility by excluding making calls using the operating system, the second dedicated core operating within the second processor.
